(19) United States
(12) Patent Application Publication
(10) Pub. No.: US 2013/0226909 A1
(43) Pub. Date: Aug. 29, 2013

(54) Stream Data Processing Method and Device

(71) Applicants: Satoshi Katsunuma, Kawasaki (JP); Tsuneyuki Imaki, Kawasaki (JP); Itaru Nishizawa, Koganel (JP); Keiro Muro, Koganei (JP)

(72) Inventors: Satoshi Katsunuma, Kawasaki (JP); Tsuneyuki Imaki, Kawasaki (JP); Itaru Nishizawa, Koganel (JP); Keiro Muro, Koganei (JP)

(73) Assignee: Hitachi, Ltd., Chiyoda-ku, Tokyo (JP)

(21) Appl. No.: 13/824,873

(22) PCT Filed: Oct. 6, 2010
(86) PCT No.: PCT/JP2010/067587

§ 371 Date: Apr. 30, 2013

(51) Int. Cl. G06F 17/30

(52) U.S. Cl. CPC G06F 17/30554
USPC 707/722

(57) ABSTRACT

Provided is a stream data processing device for processing stream data composed of input data that includes time, the device having: a data input module for receiving the input data; a first key for designating, as data sets, the items of the input data for processing the input data in chronological order; a query recorder for receiving a stream data definition and a query definition, and generating an operator to process the input data; and a data executing module for determining the operator for processing the input data and outputting results; the input module sorting the received input data for each of the data sets according to the item designated by the first key, sorting the input data in chronological order for each of the data sets, and generating an input stream; and the data executing module processing the input stream with the operator for each of the data sets.

### BACKGROUND

This invention relates to a stream data processing method and a stream data processing device.

There is an increasing demand for data processing systems that process in real time a large amount of data arriving minute by minute. Automatic buying and selling of stocks, car floating, Web access monitoring, and manufacturing monitoring can be given as examples.

Database management systems (hereinafter abbreviated as DBMSs) have been hitherto positioned at the center of data management in corporation information systems. DBMSs store data to be processed in storage, and perform highly reliable processing, typically, transaction processing, on the stored data. With DBMSs, however, search processing is conducted for every piece of data each time new data arrives, which makes it difficult to satisfy requirements of the real-time processing described above. In the case of a financial application for assisting stock trading, for instance, one of the most important objectives of the system is how quickly the system can react to fluctuations in stock prices. Data search processing in the conventional DBMSs described above is incapable of keeping up with the speed at which stock prices change, which has a very real possibility of causing the corporations to miss a business chance.

Stream data processing systems are proposed as data processing systems suitable for real-time data processing of this type. For example, a stream data processing system “STREAM” is disclosed in R. Motwani, J. Widom, A. Arasu, B. Babcok, S. Babu, M. Datar, G. Manku, C. Olston, J. Rosenstein and R. Varma, “Query Processing, Resource Management, and Approximation in a Date Stream Management System”, in Proc. of the 2003 Conf. on Innovative Data System Research (CIDR), January 2003 (Non-Patent Literature 1). In stream data processing systems, a query (inquiry) is registered first to the system, unlike conventional DBMSs, and the query is executed continuously as data arrives. Because what queries are executed can be known in advance, only a differential from the past processing result is processed when new data arrives, thereby making high-speed processing possible. Stream data processing thus enables a corporation to analyze, in real time, data that is generated at a high rate as in stock trading, and to monitor for and make use of an event that is useful to the business.

A premise of stream data processing is that input data is in chronological order, which allows a stream data processing system to sequentially process data as soon as the data is input and thus implements real-time processing. In the case where data is input from nodes (computers) installed in dispersed bases, such as stock exchange markets, base stations, or electricity meters, data from one base and data from another base are not input in chronological order, a naive method therefore accomplishes stream data processing by sorting data in chronological order at the time the data is input. However, when there are many nodes at dispersed bases or the geographical distance between bases is great, the chronological sort at data input adds to a memory cost and a processing latency. Countermeasures for input data that is not in chronological order are disclosed in US 2008/0072221 (Patent Literature 1), US 2009/0172058 (Patent Literature 2), US 2009/0172059 (Patent Literature 3), US 2010/0106946 (Patent Literature 4), J. Li, K. Tufte, V. Shkapenyuk, V. Papadimos, T. Johnson, D. Maier, “Out-of-Order Processing: a New Architecture for High-Performance Stream Systems”, in Proc. of the VLDB Endowment, 2008 (Non-Patent Literature 2), and B. Babcock, S. Babu, M. Datar, R. Motwani, and D. Thomas, “Operator Scheduling in Data Stream Systems”, 2005 (Non-Patent Literature 3). “Memory cost” refers to the amount of memory mounted on a computer that is spent to hold data waiting to be processed or the like. “Processing latency” is a delayed time, namely, a length of time from the input of stream data to a computer that processes data till the output of the data.

### SUMMARY

Patent Literature 2 and Patent Literature 3 keep the memory cost and the latency from increasing by not always waiting for input data that does not arrive in time in processing of aggregating non-chronological input data, and thus calculating the result of the processing as an approximate solution. However, data consistency or processing consistency cannot be maintained by the processing using an approximate solution alone, and Patent Literature 2 and Patent Literature 3 are therefore applicable only to a limited range of business operations and the like.

Patent Literature 1 keeps the memory cost and the latency from increasing by sending to the stream processing system a signal for permitting processing to proceed in the case where data arrival does not occur for a given period of time or longer. A problem is that, because data that arrives after a time specified in advance is discarded, processing consistency cannot be maintained.

In Non-Patent Literature 2, non-chronological inputs to a stream are permitted. A control packet for ensuring the explicit progress of time is sent to be input to an operator. The operator keeps processing data until a time of the control packet is reached. The processing of Non-Patent Literature 2 has a problem in that, when control packets are transmitted frequently, the need to process the control packets deteriorates the processing ability of a computer. Another problem is that widening the interval of control packet transmission increases the processing latency and the memory cost in the processing of Non-Patent Literature 2, where each operator waits for a control packet before executing processing.

Accordingly, it cannot be said that the known examples described above are satisfactory with regard to processing consistency and performance such as the latency and the memory cost.

An object of this invention is therefore to keep the processing latency and the memory cost from increasing while maintaining processing consistency.

A representative aspect of this invention is as follows. A stream data processing method for receiving stream data that is constituted of input data comprising time and executing processing of the stream data in accordance with a query registered in advance in a stream data processing device which comprises a processor and a memory, the stream data processing device comprising: a data inputting module which receives a plurality of pieces of input data constituting the stream data; a query registering module which receives a first key, a definition of the stream data, and a definition of the query to generate operators for processing the plurality of pieces of input data, the first key specifying, as data sets, items of the plurality of pieces of input data that are used as units by which the plurality of pieces of input data are processed in chronological order; and a data executing module which determines, for each of the data sets, which of the operators is to process the input data of the data set, and outputs a result of processing the input data of the data set with the operator, the stream data processing method comprising: a first step of receiving, by the query registering module, the first key, the definition of the query, and the definition of the stream data, and setting data sets to be processed in chronological order out of items comprised in the plurality of pieces of input data; a second step of receiving, by the data inputting module, the plurality of pieces of input data to generate an input stream; a third step of receiving, by the data executing module, the input stream and processing input data that is comprised in the input stream with the operators on a data set-by-data set basis; and a fourth step of generating results of the processing of the operators as a single output stream.

A reduction in processing latency and memory cost can be accomplished in stream data processing that handles non-chronological input data while maintaining processing consistency.

### BRIEF DESCRIPTION OF THE DRAWINGS

FIG. 1 is a block diagram illustrating a configuration example of a computer system according to a first embodiment of this invention.

FIG. 2A is a block diagram of the computer system that illustrates input/output relations of the stream data processing server according to the first embodiment of this invention.

FIG. 2B is a detailed block diagram of the data executing module of the stream data processing server according to the first embodiment of this invention.

FIG. 3A illustrate examples of a stream definition according to the first embodiment of this invention.

FIG. 3B is a definition on an electricity consumption tally query according to the first embodiment of this invention.

FIG. 3C illustrate examples of a data set key according to the first embodiment of this invention.

FIG. 4 illustrates an example of the data set conversion table according to the first embodiment of this invention.

FIG. 5 illustrates an example of the execution area name reference table according to a first embodiment of this invention.

FIG. 6 is a diagram illustrating an example of the operator tree according to the first embodiment of this invention.

FIG. 7 is a diagram illustrating an example of input data transmitted from the sending servers according to the first embodiment of this invention.

FIG. 8 is a diagram illustrating an example of the input data storage area according to the first embodiment of this invention.

FIG. 9 is a diagram illustrating an example of the input stream according to the first embodiment of this invention.

FIG. 10A is a diagram illustrating an example of the operator processing execution area A according to the first embodiment of this invention.

FIG. 10B is a diagram illustrating an example of the operator processing execution area B according to the first embodiment of this invention.

FIG. 11 illustrates an example of the execution data and the execution operator according to the first embodiment of this invention.

FIG. 12 is a diagram illustrating an example of the output data and the output stream according to the first embodiment of this invention.

FIG. 13 is a flow chart illustrating an example of processing of the query registering module according to the first embodiment of this invention.

FIG. 14A is a flow chart of the first of two parts illustrating an example of processing that is performed in the data inputting module according to the first embodiment of this invention.

FIG. 14B is a flow chart the second of two parts illustrating an example of processing that is performed in the data inputting module according to the first embodiment of this invention.

FIG. 15A is a flow chart of the first of two parts illustrating an example of processing of the data executing module according to the first embodiment of this invention.

FIG. 15B is a flow chart of the second of two parts illustrating an example of processing of the data executing module according to the first embodiment of this invention.

FIG. 16A is a time chart of the first of two parts illustrating an example of processing that is performed in the data inputting module and the data executing module according to the first embodiment of this invention.

FIG. 16B is a time chart of the second of two parts illustrating an example of processing that is performed in the data inputting module and the data executing module according to the first embodiment of this invention.

FIG. 17A is a block diagram of a computer system that illustrates input/output relations of the stream data processing server according to a second embodiment of this invention.

FIG. 17B is a detailed block diagram of the data executing module of the stream data processing server according to the second embodiment of this invention.

FIG. 18 is an explanatory diagram illustrating an example of the executable data reference table according to the second embodiment of this invention.

FIG. 19A is a block diagram illustrating an example of the execution area A according to the second embodiment of this invention.

FIG. 19B is a block diagram illustrating an example of the execution area B according to the second embodiment of this invention.

FIG. 20 is a flow chart illustrating an example of processing of the query registering module according to the second embodiment of this invention.

FIG. 21A is a flow chart of the first of two parts illustrating an example of processing of the data executing module according to the second embodiment of this invention.

FIG. 21B is a flow chart of the second of two parts illustrating an example of processing of the data executing module according to the second embodiment of this invention.

FIG. 22A is a flow chart of the first of two parts illustrating an example of processing of the data input module and the data executing module according to the second embodiment of this invention.

FIG. 22B is a flow chart of the second of two parts illustrating an example of processing of the data input module and the data executing module according to the second embodiment of this invention.

FIG. 23A is a block diagram illustrating input/output relations of the stream data processing server according to a third embodiment of this invention.

FIG. 23B is a detailed block diagram of the stream data processing server according to the third embodiment of this invention.

FIG. 24 illustrates an example of the maximum data set count according to the third embodiment of this invention.

FIG. 25 illustrates an example of the data set-stream association table 2305 of the data inputting module according to the third embodiment of this invention.

FIG. 26 illustrates an example of the output queue according to the third embodiment of this invention.

FIG. 27A illustrates an example of the duplicate stream according to the third embodiment of this invention.

FIG. 27B illustrates an example of the query definition according to the third embodiment of this invention.

FIG. 27C illustrates an example of the duplicate stream according to the third embodiment of this invention.

FIG. 27D illustrates an example of the query definition according to the third embodiment of this invention.

FIG. 27E illustrates an example of the duplicate stream according to the third embodiment of this invention.

FIG. 27F illustrates an example of the query definition according to the third embodiment of this invention.

FIG. 28 is a flow chart illustrating an example of processing of the query registering module according to the third embodiment of this invention.

FIG. 29 is a flow chart illustrating an example of processing of the data inputting module according to the third embodiment of this invention.

FIG. 30 is a flow chart illustrating an example of processing of the stream merging module according to the third embodiment of this invention.

FIG. 31A is a time chart of the first of two parts illustrating an example of processing of the data inputting module, the data executing modules (#1 and #2), and the stream merging module.

FIG. 31B is a time chart of the second of two parts illustrating an example of processing of the data inputting module, the data executing modules (#1 and #2), and the stream merging module.

### DETAILED DESCRIPTION OF THE PREFERRED EMBODIMENTS

Embodiments of this invention are described below with reference to the accompanying drawings.

### First Embodiment

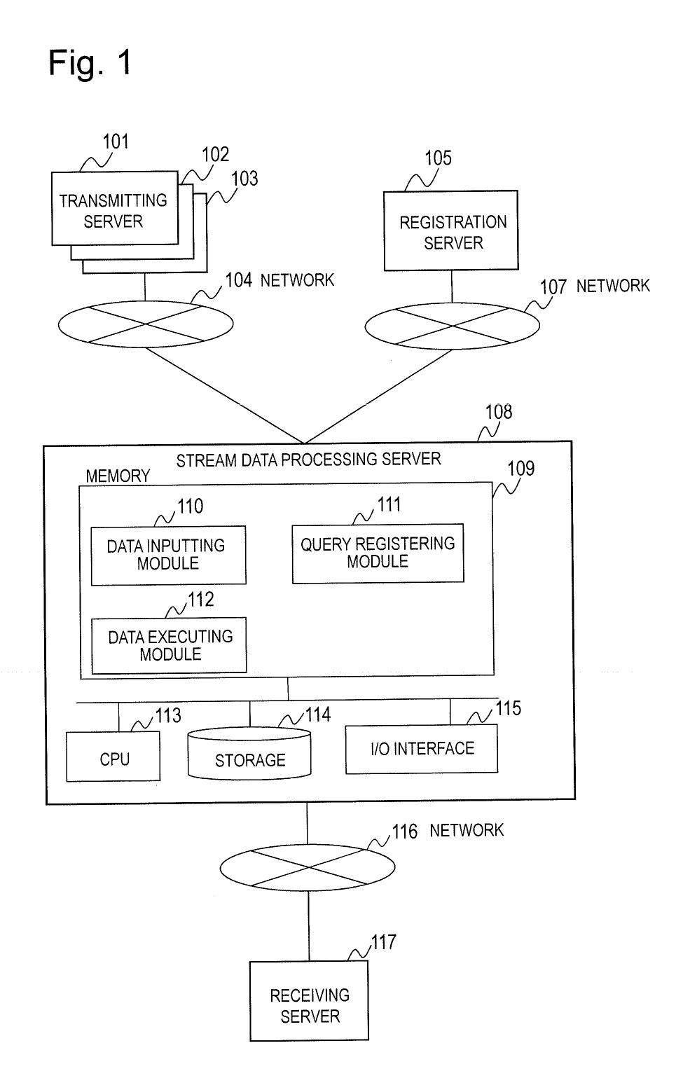

FIG. 1 is a block diagram illustrating a configuration example of a computer system according to a first embodiment of this invention. Sending servers 101 to 103 are coupled via a network 104 to a stream data processing server 108, which executes a stream data processing system. A registration server 105 is coupled to the stream data processing server 108 via a network 107. A receiving server 117 is coupled to the stream data processing server 108 via a network 116. The networks 104, 107, and 116 may be Ethernet networks, or may be local area networks (LANs) connected by optical fibers or the like, or may be wide area networks (WANs) that include the Internet slower than LANs. The stream data processing server 108, the sending servers 101 to 103, the registration server 105, and the receiving server 117 can each be constituted of a personal computer (PC) or an arbitrary computer system such as a blade computer system.

The stream data processing server 108 is a computer in which an I/O interface 115 constituting an interface unit, a central processing unit (CPU) 113 constituting a processing unit, and a memory 109 serving as a storing unit are joined to one another by a bus.

The stream data processing server 108 accesses the networks 104, 107, and 116 via the I/O interface 115. The CPU 113 (or the processor 113) can use storage 114, which is a storing unit, as non-volatile storage for storing a result of stream data processing, an intermediate result of processing, or settings data necessary for system operation. The storage 114 is connected directly with the use of the I/O interface 115, or is coupled via a network with the use of the I/O interface 115. The memory 109 stores, as modules constituting stream data processing, a query registering module 111, a data inputting module 110, and a data executing module 112. The operation of the respective modules is described later.

The first embodiment is described below with reference to the drawings. The first embodiment discusses a method of carrying out this invention based on operator scheduling that is disclosed in Patent Literature 4.

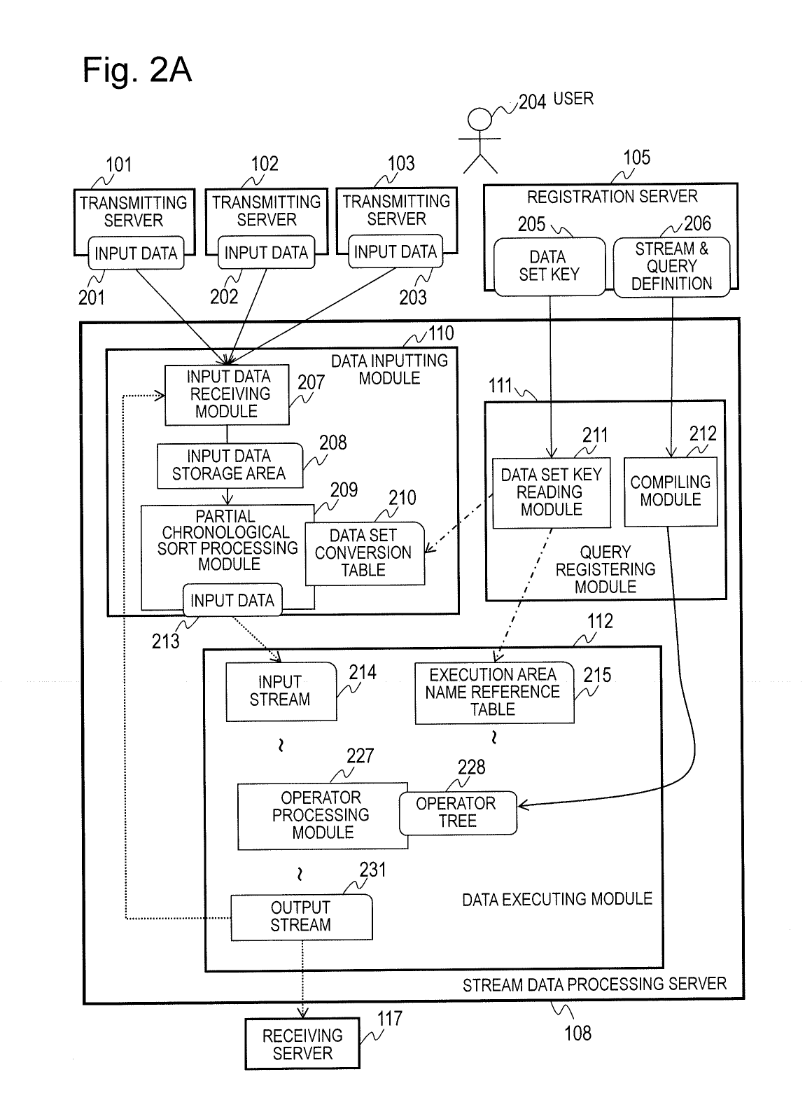

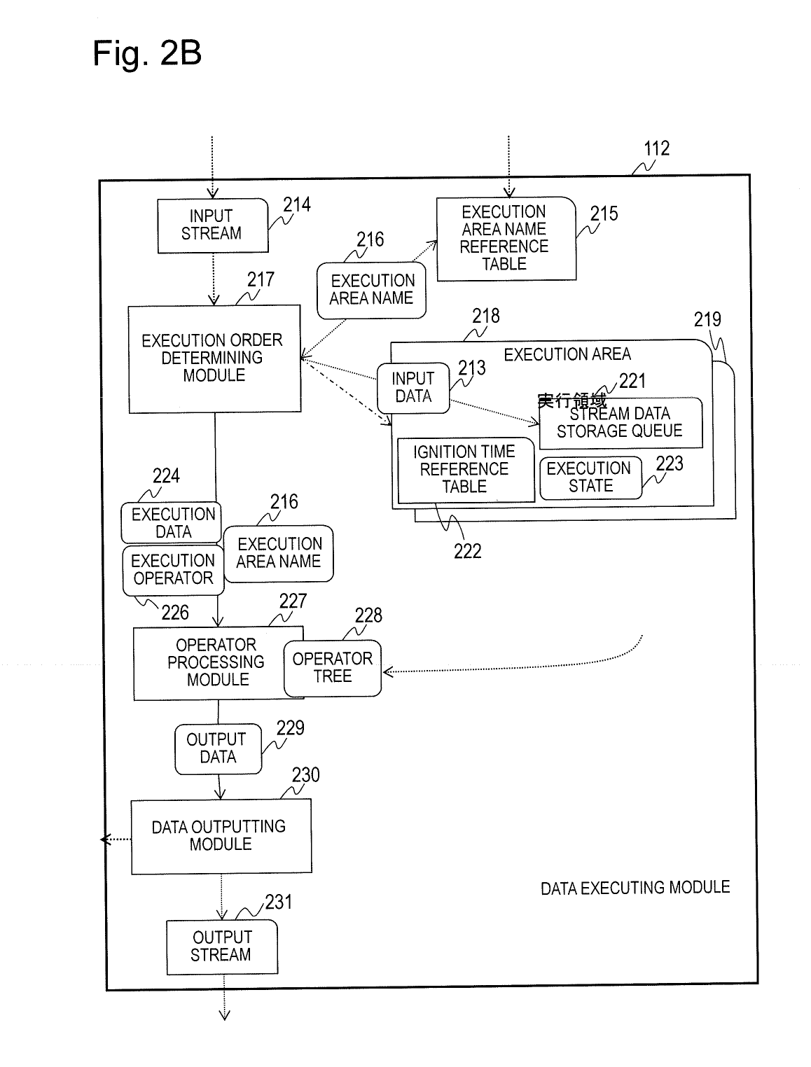

FIGS. 2A and 2B are block diagrams illustrating the configuration of the stream data processing server 108 of the first embodiment. FIG. 2A is a block diagram of the computer system that illustrates input/output relations of the stream data processing server 108. FIG. 2B is a detailed block diagram of the data executing module 112 of the stream data processing server 108.

First, settings data which includes a stream and query definition 206 written by a user 204 and a data set key 205 is stored in the registration server 105 and transmitted from the registration server 105 to the stream data processing server 108. After receiving the settings data, the stream data processing server 108 uses a data set key reading module 211 of the query registering module 111 to generate a data set conversion table 210 and an execution area name reference table 215 from the data set key 205. The stream data processing server 108 also uses a compiling module 212 to compile the stream and query definition 206 and generate an operator tree 228.

After the stream data processing server 108 generates the data set conversion table 210, the execution area name reference table 215, and the operator tree 228, the sending servers 101 to 103 keep sending input data 201 to input data 203 to the stream data processing server 108.

The input data 201 to input data 203 are received by an input data receiving module 207 of the data inputting module 110 in the stream data processing server 108. The received input data is stored in an input data storage area 208. The input data storage area 208 is constituted of queues for temporarily holding the received input data 201 to input data 203. A partial chronological partition processing module 209 uses the data set conversion table 210 to partially sort, in chronological order, the input data 201 to input data 203 stored in the input data storage area 208. The sorted input data, which is denoted by 213, is stored in an input stream 214. The data inputting module 110 outputs the input stream to the data executing module 112.

The data executing module 112 uses an execution order determining module 217 to take the stored input data 213 out of the input stream 214. The execution order determining module 217 refers to the execution area name reference table 215 to extract an execution area name 216 when there is at least one of execution areas 218 and 219, and to generate a new execution area when there are no execution areas. The execution areas 218 and 219 are each constituted of a stream data storage queue 221, an ignition time reference table 222, and an execution state 223.

The execution order determining module 217 stores the input data 213 in the stream data storage queue 221 of the execution area 218 specified by the extracted execution area name 216, and uses the ignition time reference table 222 of the execution area 218 to extract execution data 224 and an execution operator 226.

An operator processing module 227 of the data executing module 112 executes given processing using the execution data 224, which is extracted by the execution order determining module 217, and the operator tree 228 of the execution operator 226. When executing the processing, the operator processing module 227 uses the execution state 223 of the execution area 218 specified by the execution area name 216.

Output data 229 which is output as a result of the execution of the operator processing module 227 is stored in an output stream 231 by a data outputting module 230. Data stored in the output stream 231 is received by the receiving server 117. In the case where operator processing is to be further performed on the data stored in the output stream 231, the data stored in the output stream 231 is received by the input data receiving module 207.

Details of the operation in the first embodiment are described next.

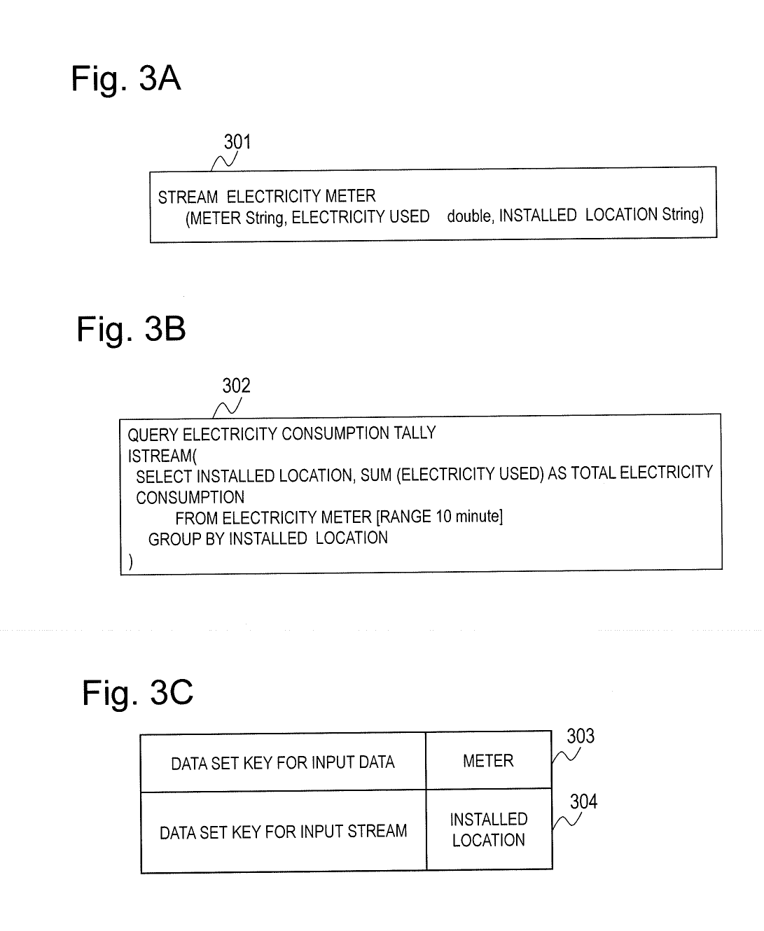

FIGS. 3A to 3C illustrate examples of a stream definition 301 and a query definition 302, which are included in the stream and query definition 206, and the data set key 205. The definition 301 of FIG. 3A is a definition on an electricity meter stream which has electricity “meter”, “electricity used”, and the meter's “installed location” as columns (or data items). This stream definition 301 is a definition used by the stream data processing server 108 to identify a plurality of items included in the input data 201 to input data 203 which constitute stream data. While the input data 201 to input data 203 include a time (or a timestamp), a definition on time is omitted from the stream definition 301 because a premise of this embodiment is that time information is attached to the input data 201 to input data 203.

The definition 302 of FIG. 3B is a definition on an electricity consumption tally query for inputting the electricity meter stream definition 301 and outputting total electricity consumption every ten minutes for each installed location. This query definition 302 is a definition for determining which operator is to process the input data 201 to input data 203.

For these stream definition 301 and query definition 302, the data set key 205 (303 and 304) of FIG. 3C is specified by the user via the registration server 105.

The data set key 205 is constituted of the data set key 304 for an input stream (a first key) and the data set key 303 for input data (a second key). The first embodiment discusses an example in which “meter” out of the columns of input data is set as the data set key 303 for input data, and “installed location” out of the columns of input data is set as the data set key 304 for an input stream.

The data set key 303 for input data indicates that pieces of input data that have the same value in a specified column are organized in chronological order to be input to the data inputting module 110 of the stream data processing server 108. Specifically, the data set key 303 indicates that pieces of input data are input organized in chronological order for each “meter”.

The data set key 304 for an input stream indicates that pieces of input data that have the same value in a specified column are treated as a group processed in a query to be processed in chronological order in the input stream 214 of the data executing module 112. Specifically, the data set key 304 indicates that pieces of input data are sorted by “installed location” to constitute data sets so that input data is processed in chronological order on a data set-by-data set basis. The data set key 304 for an input stream also indicates that the data executing module 112 generates as many execution areas as the number of types of “installed location” of input data. In other words, a data set is constructed for each “installed location” type of input data.

The data set key 303 for input data and the data set key 304 for an input stream may be specified by writing the data set keys in a query, or may be specified via a settings file, or may be specified by other methods.

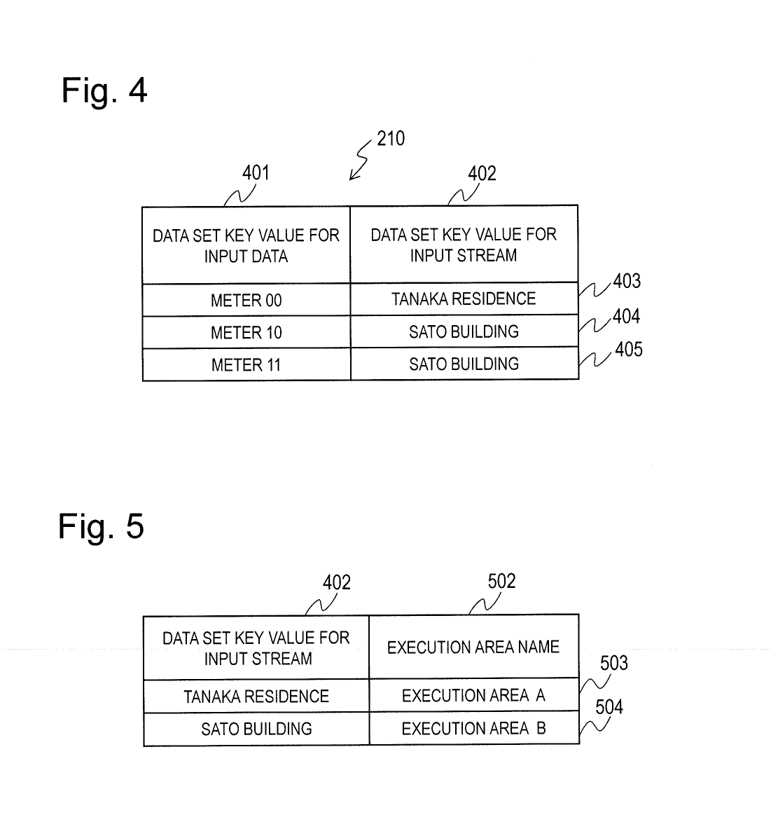

FIG. 4 illustrates an example of the data set conversion table 210. The data set conversion table 210 is a table for setting a relation between the data set key 303 for input data and the data set key 304 for an input stream, which are set in FIG. 3C, with respect to input data stored in the input data storage area 208.

In the example of FIG. 4, a meter is specified as a data set key value 401 for input data and an installed location is specified as a data set key value 402 for an input stream. Based on the data set key settings of FIG. 3C, a meter “meter 00” is associated with an installed location “Tanaka residence” (403), a meter “meter 10” is associated with an installed location “Sato Building” (404), and a meter “meter 11” is associated with an installed location “Sato Building” (405).

FIG. 5 illustrates an example of the execution area name reference table 215. The execution area name reference table 215 shows an association relation between the data set key value 402 for an input stream and an execution area name 502 of an independent execution area where input data is actually processed. In the example of FIG. 5, an installed location is specified as the data set key value 402 for an input stream as in FIG. 4, and an installed location “Tanaka residence” is associated with an execution area name “execution area A” (503) while an installed location “Sato Building” is associated with an execution area name “execution area B” (504).

The example of FIG. 5 is an example of generating an independent execution area for each data set key 304 for an input stream out of the data set keys of FIG. 3C. In this example, the input data storage area 208 contains two different data set key values 402 for an input stream, “Tanaka residence” and “Sato Building”, and the independent execution area A (503) and execution area B (504) are generated in the execution area name reference table 215 for the respective data set key values 402 for an input stream.

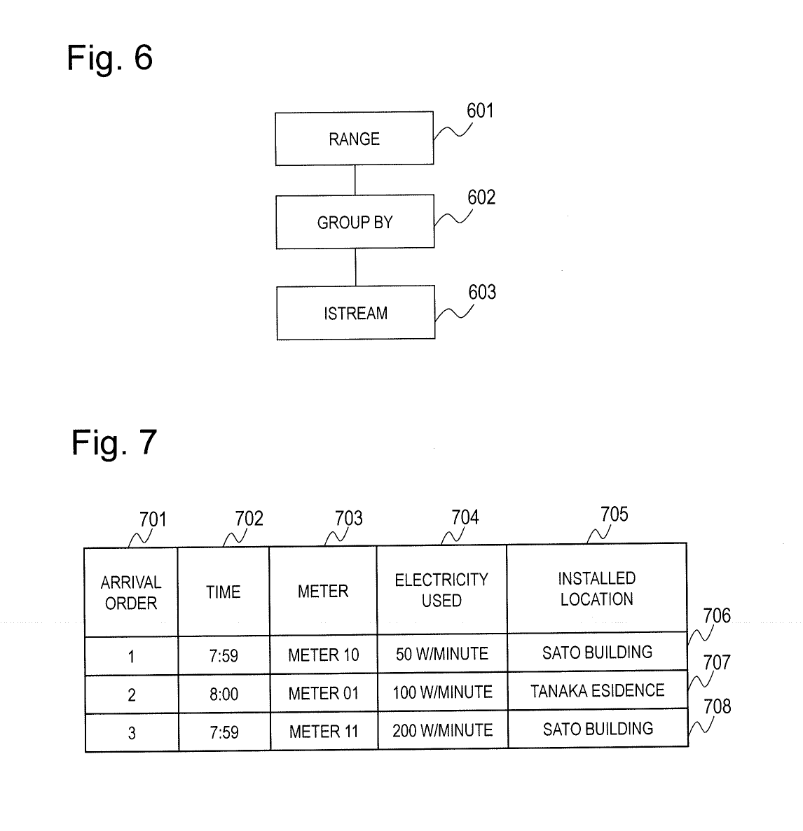

FIG. 6 is a diagram illustrating an example of the operator tree 228. The operator tree of FIG. 6 is an operator tree generated in the query registering module 111 by compiling the electricity consumption tally query definition 302, and is constituted of an operator RANGE 601, an operator GROUP BY 602, and an operator ISTREAM 603. The operator tree of FIG. 6 indicates that the operators RANGE 601, GROUP BY 602, and ISTREAM 603 are executed in the order stated in the operator processing module 227 of the data executing module 112.

FIG. 7 is a diagram illustrating an example of input data transmitted from the sending servers 101 to 103. The input data of FIG. 7 is data input to the electricity meter stream definition 301 of FIG. 3A. Each piece of input data has values including an arrival order 701 of the piece of input data, a time 702 attached to the piece of input data, and a meter 703, electricity used 704, and an installed location 705 which are items of the electricity meter stream definition 301.

In FIG. 7, input data 706, input data 707, and input data 708 are received by the stream data processing server 108 in the order stated. The input data 706 contains a time “7:59”, a meter “meter 10”, used electricity “50 W/minute”, and an installed location “Sato Building”. The input data 707 contains a time “8:00”, a meter “meter 01”, used electricity “100 W/minute”, and an installed location “Tanaka residence”. The input data 708 contains a time “7:59”, a meter “meter 11”, used electricity “200 W/minute”, and an installed location “Sato Building”.

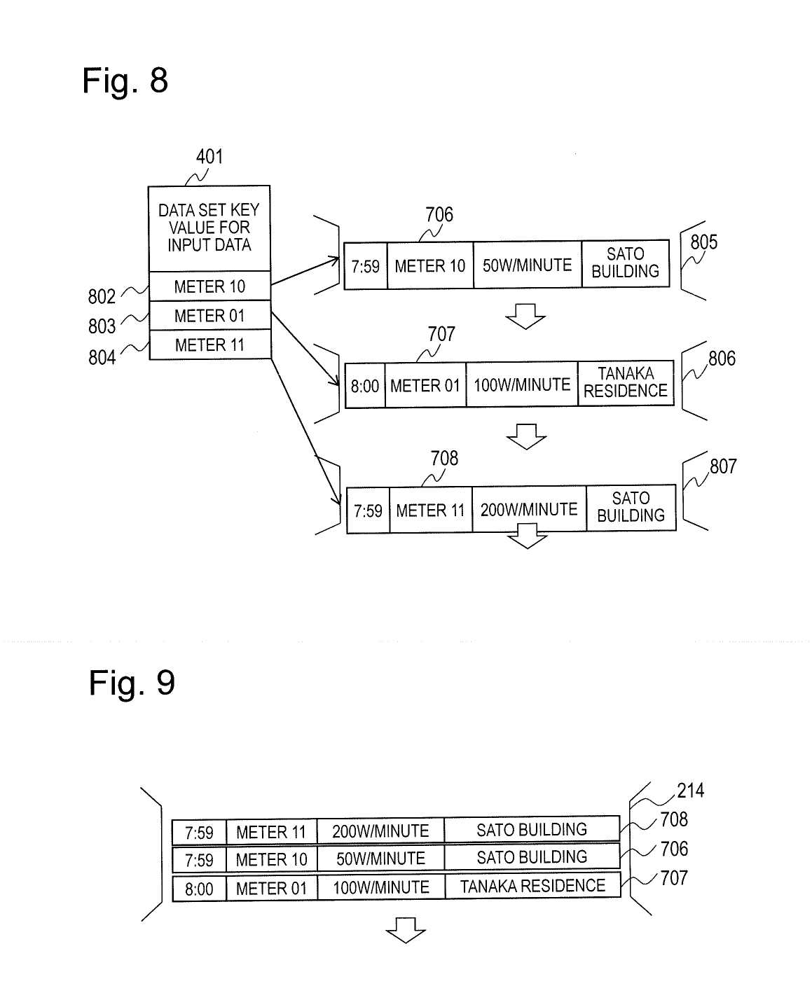

FIG. 8 is a diagram illustrating an example of the input data storage area 208. The input data storage area 208 has queues 805 to 807 in which input data received from the sending servers 101 to 103 is stored for each data set key value 401 for input data illustrated in FIG. 4. The input data storage area 208 of FIG. 8 stores “meter” data out of input data of the electricity meter stream definition 301 when “meter” is specified as the data set key value 401 for input data as in FIG. 4.

In FIG. 8, the queue 805 stores the input data 706 of “meter 10” (802), the queue 806 stores the input data 707 of “meter 01” (803), and the queue 807 stores the input data 708 of “meter 11” (804). In other words, the data inputting module 110 generates in the memory 109 a queue for storing input data for each data set key value 401 for input data, and stores the input data 201 to input data 203 (706, 707, and 708) in the queues.

FIG. 9 is a diagram illustrating an example of the input stream 214. The input stream 214 stores input data on which operator processing is executed. This invention, unlike the examples of the related art, does not require that all pieces of input data in the input stream 214 be arranged in chronological order, and only pieces of data that have the same data set key value 401 for input data need to be arranged in chronological order. The input stream 214 is an example of an input stream that is generated by the data inputting module 110 following the electricity meter stream definition (301) of FIG. 3A.

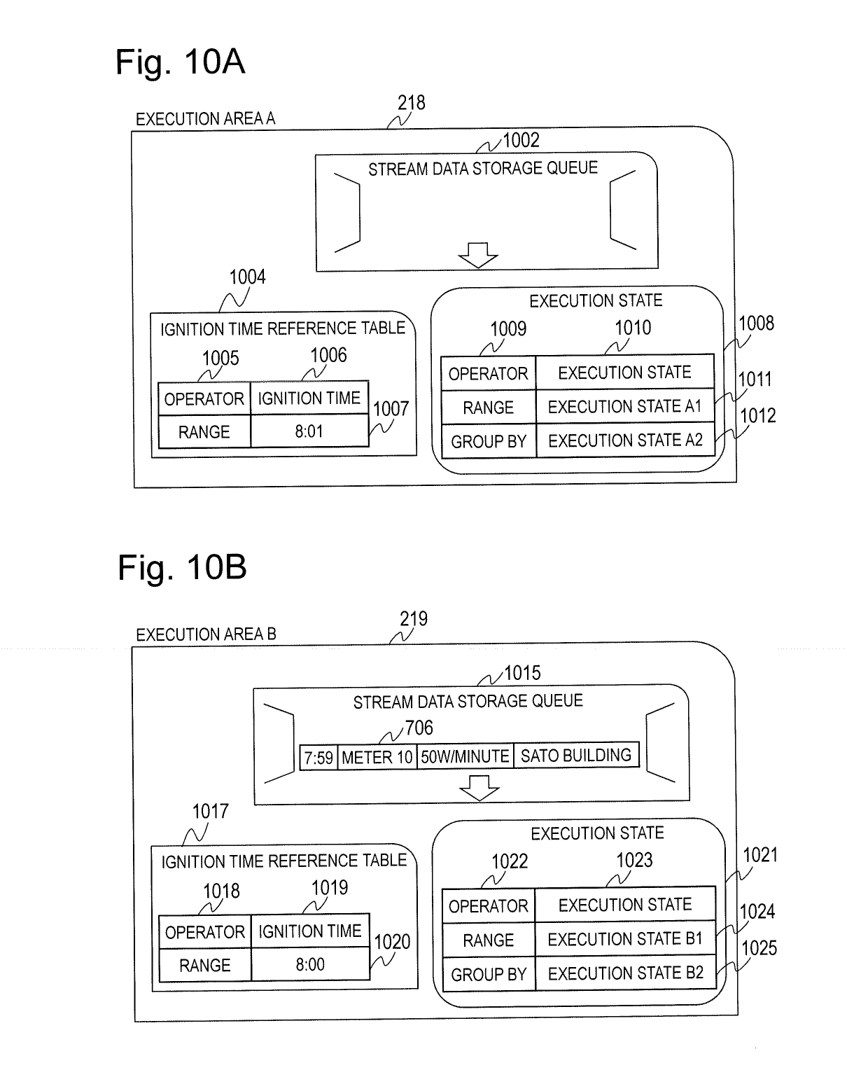

FIG. 10A and FIG. 10B are diagrams illustrating an example of the operator processing execution areas 218 and 219 which are generated independently of each other. An execution area is generated by the data executing module 112 for each data set key value 402 for an input stream. In FIG. 10A, the execution area A (218) is generated as an execution area for the data set key value 402 for an input stream that is an installed location “Tanaka residence”. In FIG. 10B, the execution area B (219) is generated as an execution area for the data set key value 402 for an input stream that is an installed location “Sato Building”. The execution areas 218 and 219 respectively include stream data storage queues 1002 and 1015 for storing the input stream 214, ignition time reference tables 1004 and 1017 in which a time to start operator processing for the input stream 214 is set, and execution states 1008 and 1021 which indicate the state of an operator. The execution states 1008 and 1021 are collectively denoted by reference symbol 223. The execution state 223 stores, for example, the processing result of an operator so that the stored value indicates the state of the operator.

The stream data storage queues 1002 and 1015 are queues for storing the input data 213 in the input stream 213 that has the data set key value 402 for an input stream for the input stream 214. The stream data storage queues 1002 and 1015 are collectively denoted by reference symbol 221.

The ignition time reference tables 1004 and 1017 respectively hold information about processing of input data stored in the stream data storage queues 1002 and 1015, specifically, operators 1005 and 1018 which execute the processing and ignition times 1006 and 1019 which are times to execute the operators.

For example, in the case where the ignition time 1006 of the operator RANGE in the execution area A (218) has “7:51” as the time of the oldest data in the operator RANGE, the next ignition time is “8:01” (1007), which is calculated by adding ten minutes to the last execution time, “7:51+10 minutes”, because the tally period is a ten-minute window as indicated by the electricity consumption tally query definition 302 of FIG. 3B. Similarly, in the case where the ignition time of the operator RANGE in the execution area B has “7:50” as the time of the oldest data in the operator RANGE, the next ignition time is “8:00” (1029), which is also calculated by adding the ten-minute window, “7:50+10 minutes”. These ignition times can be set by the execution order determining module 217.

The execution states 1008 and 1021 respectively indicate states that are used in processing executed by the operators on input data stored in the stream data storage queues 1002 and 1015. For instance, in an execution state A1 (1011) and an execution state B1 (1024) which are execution states of the operator RANGE, input data that contains a time within ten minutes from the current time is stored in the respective execution areas because the tally period is a ten-minute window. In an execution state A2 (1012) and an execution state B2 (1025) which are execution states of the operator GROUP BY, an aggregation value of input data that contains a time within ten minutes from the current time is stored.

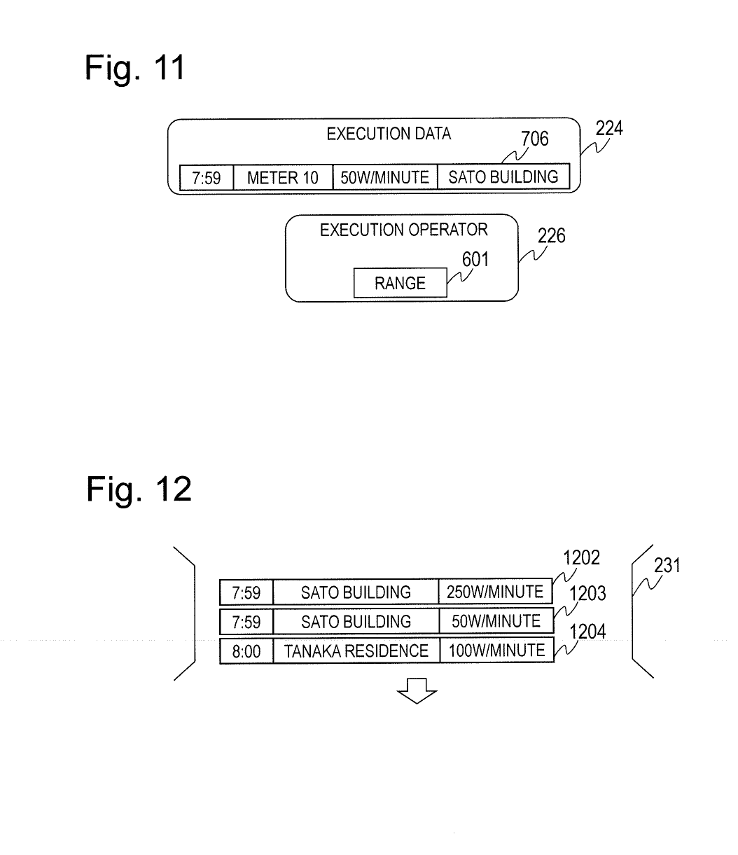

FIG. 11 illustrates an example of the execution data 224 and the execution operator 226. The execution data 224 is data executed by the operator processing module 227. The execution operator 226 is an operator that executes processing on the execution data 224 in the operator processing module 227. In FIG. 11, the input data 706 of FIG. 7 is given as an example of the execution data 224 and the operator RANGE 601 of FIG. 6 is given as an example of the execution operator 226.

FIG. 12 is a diagram illustrating an example of the output data 229 and the output stream 231. Output data is the processing result of an operator which is obtained by the receiving server 117 or the input data receiving module 207. The output stream 231 is an area for storing output data. The output stream 231 of FIG. 12 is an output stream for storing output data 1202 to output data 1204 of the electricity consumption tally query definition 302. The output data 1203, the output data 1204, and the output data 1202 correspond to the processing result of the input data 706, the processing result of the input data 707, and the processing result of the input data 708, respectively. The output data 1202 to output data 1204 are collectively denoted by the reference symbol 229 used in FIG. 2B.

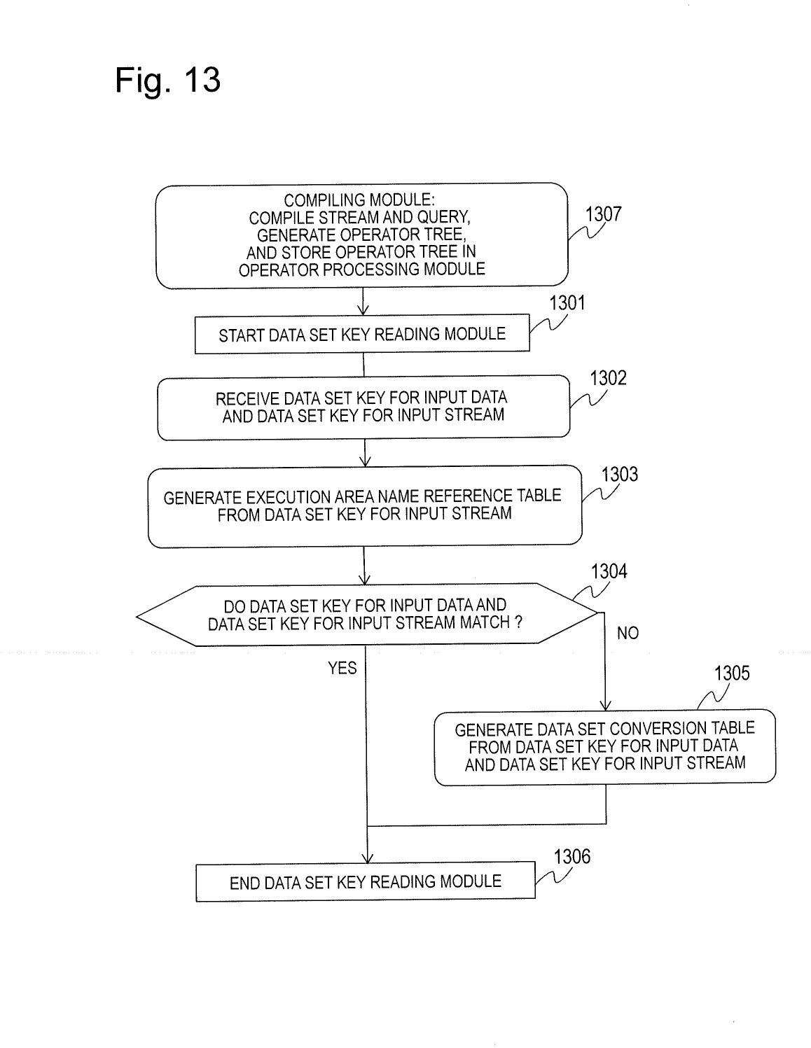

FIG. 13 is a flow chart illustrating an example of processing of the query registering module 111. First, as in the stream data processing method of the examples of the related art, the query registering module 111 receives and then compiles the stream definition 301 and the query definition 302, which are defined in the registration server 105, to generate an operator for processing input data and the operator tree 228 (FIG. 6) of the operator. The query registering module 111 stores the generated operator tree 228 in the operator processing module 227 (1307).

After the compiling, the query registering module 111 starts the reading of the data set key 205 in the data set key reading module 211 (1301). The data set key reading module 211 receives from the registration server 105 the data set key 303 for input data and the data set key 304 for an input stream which constitute the data set key 205 (1302).

Next, the data set key reading module 211 generates the execution area name reference table 215 (FIG. 5) which indicates the association relation between the received data set key value 402 for an input stream and the execution area name 502 (1303). The generated execution area name reference table 215 may contain data such as data of the entries 503 and 504 of FIG. 5, or may be an empty table devoid of data.

In the case where the data set key 303 for input data and the data set key 304 for an input stream match (1304), the query registering module 111 ends the data set key reading module (1306).

In the case where the data set key 303 for input data and the data set key 304 for an input stream match do not match in Step 1304, on the other hand, the query registering module 111 generates the data set conversion table 210 (FIG. 4) which indicates the association relation between the data set key value 401 for input data and the data set key value 402 for an input stream (1305). The generated data set conversion table 210 may contain data such as data of the entries 403 to 405 of FIG. 4, or may be an empty table devoid of data.

After generating the data set conversion table 210, the query registering module 111 ends the data set reading module (1306).

Through the processing described above, the query registering module 111 compiles the stream definition 301 and the query definition 302, which are defined in the registration server 105, to generate an operator and the operator tree 228, and generates the data set conversion table 210 and the execution area name reference table 215 from the data set key 205, which is defined in the registration server 105. This processing can be executed when the query registering module 111 receives the stream and query definition 206 and the data set key 205 from the registration server 105.

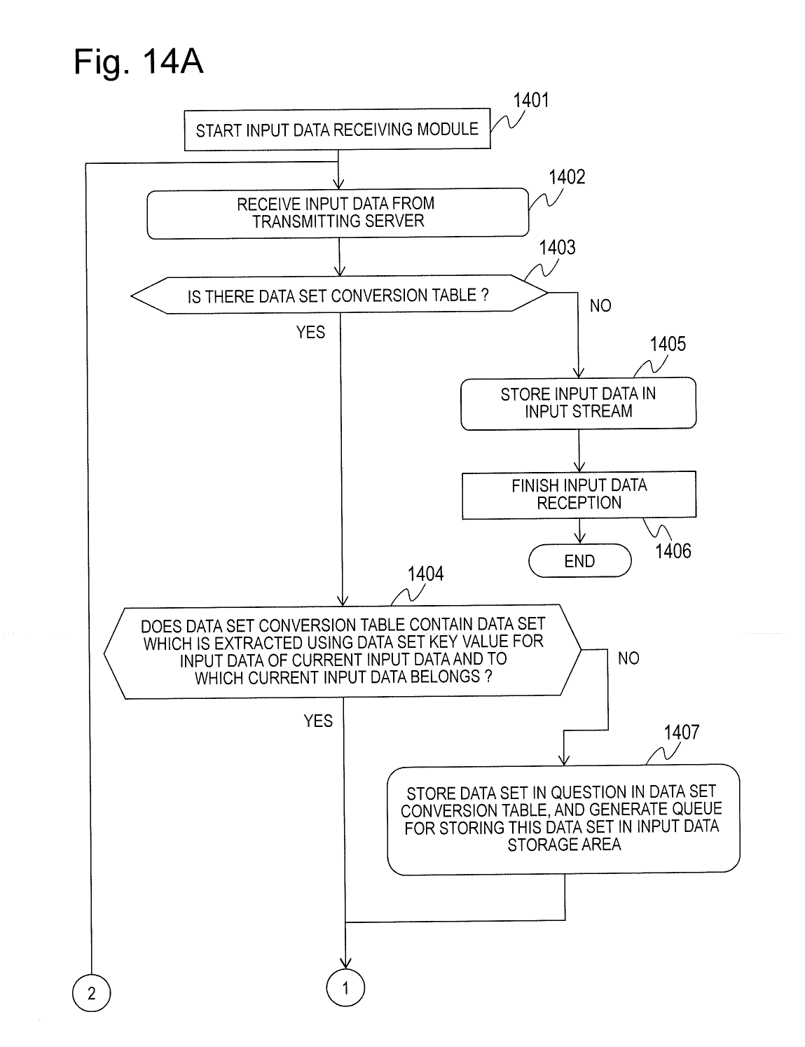

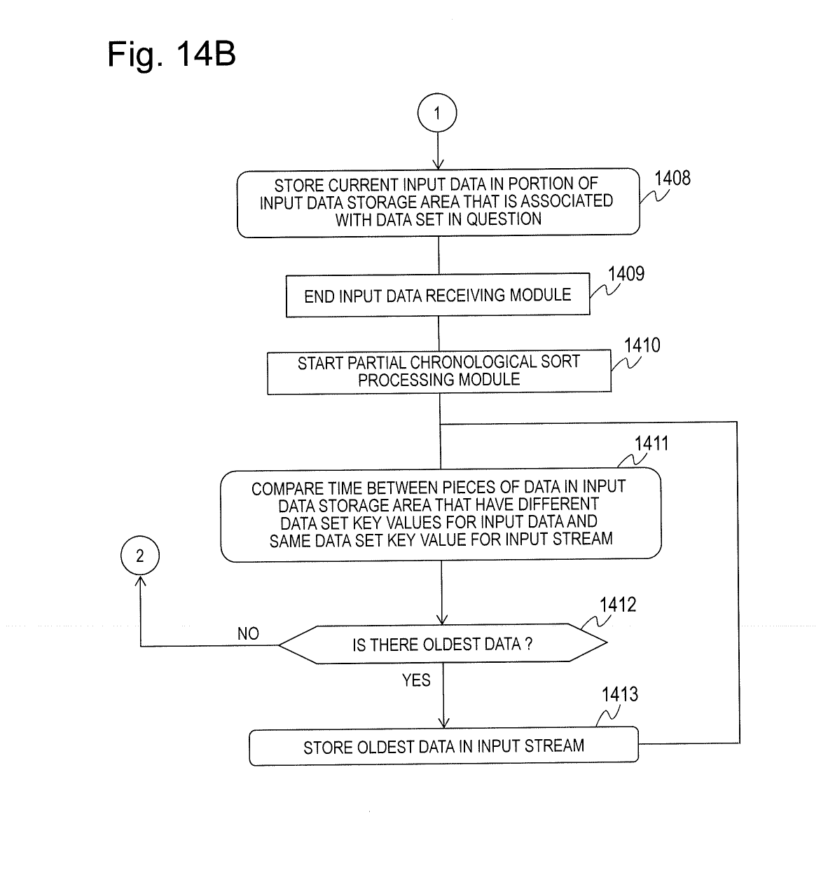

FIGS. 14A and 14B are diagrams illustrating an example of processing that is performed in the data inputting module 110. The data inputting module 110 first uses the input data receiving module 207 (1401) to receive the input data 201 to input data 203 from the sending servers 101 to 103 (1402).

The data inputting module 110 then determines whether there is the data set conversion table 210 or not (1403). When there is no data set conversion table, the data inputting module 110 stores the input data 201 to input data 203 in the input stream 214 (1405), outputs the input stream 214 to the data executing module 112, and then ends the processing of the input data receiving module 207 (1406).

When it is determined in Step 1403 that there is the data set conversion table 210, on the other hand, the data inputting module 110 executes the following processing. In the case where the data set conversion table 210 contains the data set key value 401 for input data that is one of the items of the input data 201 to input data 203 (1404), the data inputting module 110 stores the input data in a queue of the input data storage area 208 that is determined by the input data set key value 401 for input data (1408), and ends the processing of the input data receiving module 207 (1409).

To give an example, how the data set conversion table 210 and the input data storage area 208 look when the data inputting module 110 receives the input data 708 of FIG. 7 (when the input data arrives) is illustrated in FIGS. 4 and 8.

Here, “meter” is specified as a data set key for input data as in 303 of FIG. 3C, and the input data 708 of FIG. 7 has “meter 11” as the value of the meter 703. The data inputting module 110 therefore generates the queue 807 of the input data storage area 208 and stores the input data 708 in the queue 807.

In the case where the data set key value 401 for input data of the input data 201 to input data 203 is not found in the data set conversion table 210 in Step 1404, the data inputting module 110 stores the data set key value 401 for input data and data set key value 402 for an input stream of the received input data in the data set conversion table 210. The data inputting module 110 also generates a queue that is associated with the data set key value 401 for input data of the received input data in the input data storage area 208 (1407).

The data inputting module 110 then stores the input data in a queue of the input data storage area 208 that is determined by the data set key value 401 for input data (1408), and ends the processing of the input data receiving module 207 (1409).

Instead of the input data 201 to input data 203 from the sending servers 101 to 103, dummy data that has the data set key value 401 for input data, the data set key value 402 for an input stream, and a time may be input to the data inputting module 110. The input data receiving module 207 in this case stores the data set key value 401 for input data and data set key value 402 for an input stream of the dummy data in the data set conversion table 210, and adds a queue associated with the data set key value 401 for input data of the dummy data to the input data storage area 208, the same way the input data described above is processed.

Alternatively, dummy data that has the data set key value 401 for input data, the data set key value 402 for an input stream, a time, and an end flag may be input so that the input data receiving module 207 can execute the following processing. In an example of this processing, the input data receiving module 207 first reads the end flag. When the end flag has a given value and the data set conversion table 210 contains a data set which is extracted using the data set key value 401 for input data of the dummy data and to which the input data belongs, the input data receiving module 207 deletes the data set key value 401 for input data and data set key value 402 for an input stream of the dummy data from the data set conversion table 210. The input data receiving module 207 also removes the queue associated with the data set key value 401 for input data of the dummy data from the input data storage area 208. An entry of the data set conversion table 210 and a queue in the input data storage area 208 can be removed by using the dummy data described above. This prevents the amount of the memory 109 that is used by the data inputting module 110 from reaching an excessive level.

Queues in the input data storage area 208 can be generated in an order that data arrives at the data inputting module 110 as is the case for the queues 805 to 807 of FIG. 8. The data inputting module 110 generates a queue for each data set key value 401 for input data (“meter” in this embodiment). In the example of FIG. 8, the data inputting module 110 generates the queue 805 for storing input data of “meter 10”, the queue 806 for storing input data of “meter 01”, and the queue 807 for storing input data of “meter 11”. Pieces of input data sorted by “meter” are stored in the respective queues 805 to 807 in an order that the pieces of input data arrive at the data inputting module 110. In other words, the data inputting module 110 sorts input data by an item specified by the data set key value 401 for input data, and stores the sorted input data in the queues 805 to 807.

When it is determined in Step 1404 that there is the data set conversion table 210, processing of the partial chronological partition processing module 209 is started next (1410).

The partial chronological partition processing module 209 first compares time between pieces of data at the head of queues in the input data storage area 208 that have the same data set key value 402 for an input stream (1411). In this processing, the partial chronological partition processing module 209 compares the times (values of the time 702 of FIG. 7) of pieces of input data that are stored at the head of queues in the input data storage area 208 and that have different data set key values 401 for input data and the same data set key value 402 for an input stream.

Specifically, after the pieces of input data of FIG. 7 are stored in the queues 805 to 807 of the input data storage area 208, the partial chronological partition processing module 209 compares the time 702 between pieces of input data that have the same “installed location” value as the data set key value 402 for an input stream which is the first key and different “meter” values as the data set key value 401 for input data which is the second key.

The partial chronological sort processing module 209 next determines, based on the result of the comparison described above, whether or not there is data having the earliest time (hereinafter referred to as oldest data) among pieces of input data that have the same data set key value 402 for an input stream in the input data storage area 208 (1412).

In the case where there is the oldest data (1412), the partial chronological sort processing module 209 obtains the oldest data from the queues 805 to 807 of the input data storage area 208 and stores the obtained data in the input stream 214 (1413). Steps 1411 to 1413 are repeated as long as there is the oldest data. When the oldest data is no longer found, the partial chronological partition processing module 209 moves to Step 1402 to receive new input data from the sending servers.

To give an example, FIG. 9 illustrates how the input stream 214 looks after the data inputting module 110 receives the input data 708. The “installed location” of the meter is set as the data set key 304 for an input stream as illustrated in FIG. 3C, and the installed location of the meter of the input data 708 is “Sato Building” as illustrated in FIG. 8. The partial chronological sort processing module 209 therefore compares the times of the data 706 and the data 708 which are respectively at the head of the queues 805 and 807 for storing input data that has “Sato Building” as the installed location. The queue 807 does not contain data that is earlier than the time of the data 706 in the queue 805. The data 706 is consequently set as the oldest data and stored in the input stream 214. Similarly, because the queue 805 does not contain data that is earlier than the time of the data 708, the data 708 is set as the oldest data and stored in the input stream 214. As a result, the partial chronological sort processing module 209 generates the input stream 214 in which the input data 706 and the input data 708 both having “Sato Building” as the data set key value 402 for an input stream are sorted in chronological order, and outputs the input stream 214 to the data executing module 112.

Through the processing described above, the partial chronological partition processing module 209 generates the input stream 214 by sorting, in ascending order of the time 702, pieces of input data of FIG. 7 that have the same value as “installed location” specified by the data set key value 402 for an input stream which is the first key and have different values as “meter” specified by the data set key value 401 for input data which is the second key, and outputs the input stream 214 to the data executing module 112. The partial chronological partition processing module 209 can thus output the input stream 214 in which pieces of input data that are grouped together by “installed location” specified by the data set key value 402 for an input stream which is the first key are sorted in chronological order.

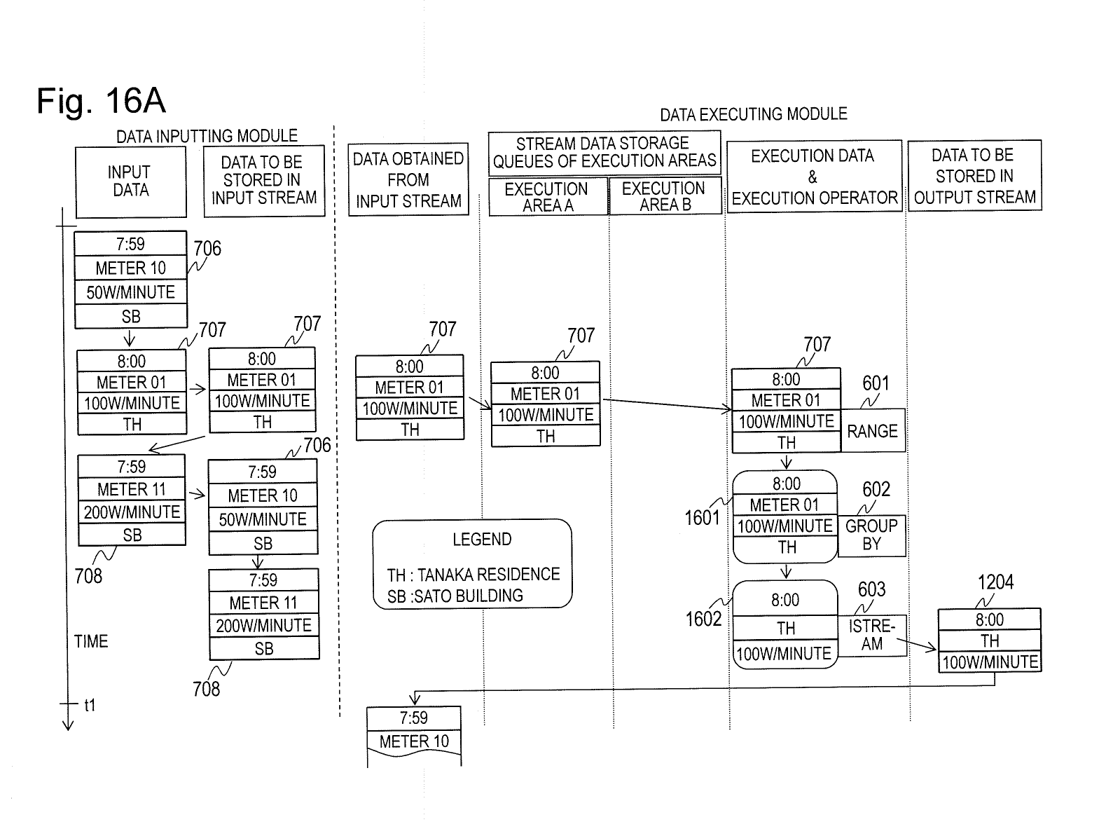

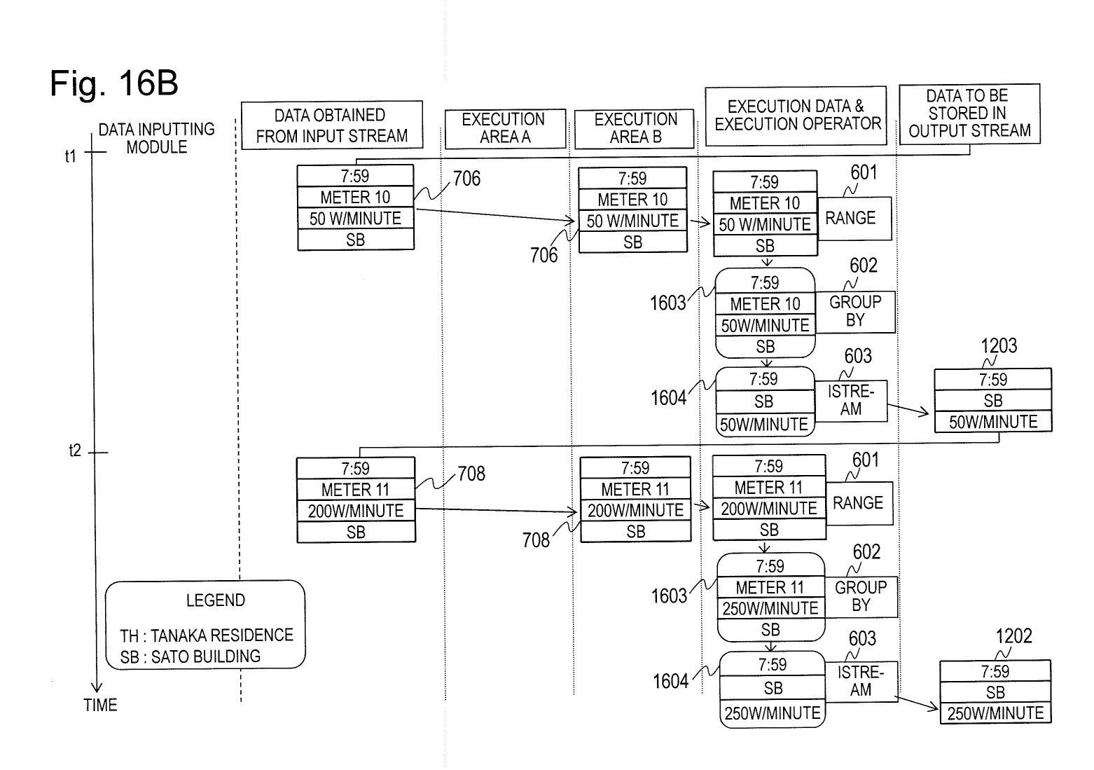

FIGS. 16A and 16B are time charts illustrating activities that are observed in the data inputting module 110 and the data executing module 112 when the input data 706 to input data 708 arrive at the stream data processing server 108.

When receiving the input data 708, the data inputting module 110 stores the input data 706 and the input data 708 in the input stream 214 as described above with reference to FIG. 9, and outputs the input stream 214 to the data executing module 112. When receiving the input data 707, the data inputting module 110 stores the input data 707 in the input stream 214 and outputs the input stream 214 to the data executing module 112 because input data that has other meters than “meter 01” as the data set key value for input data is not found among pieces of data that have the same installed location as one specified by the data set key value 402 for an input stream of the input data 707, namely, “Tanaka residence”, and the input data 707 which is the oldest data among pieces of data of “meter 01” is accordingly the oldest data for “Tanaka residence”.

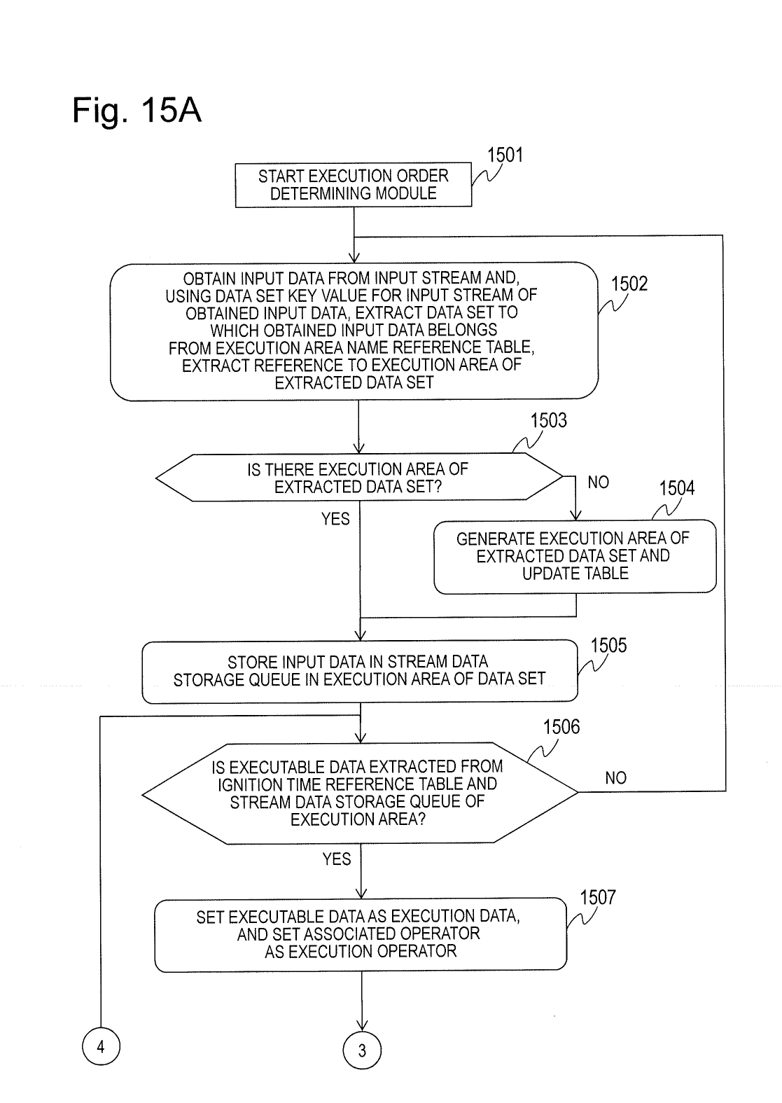

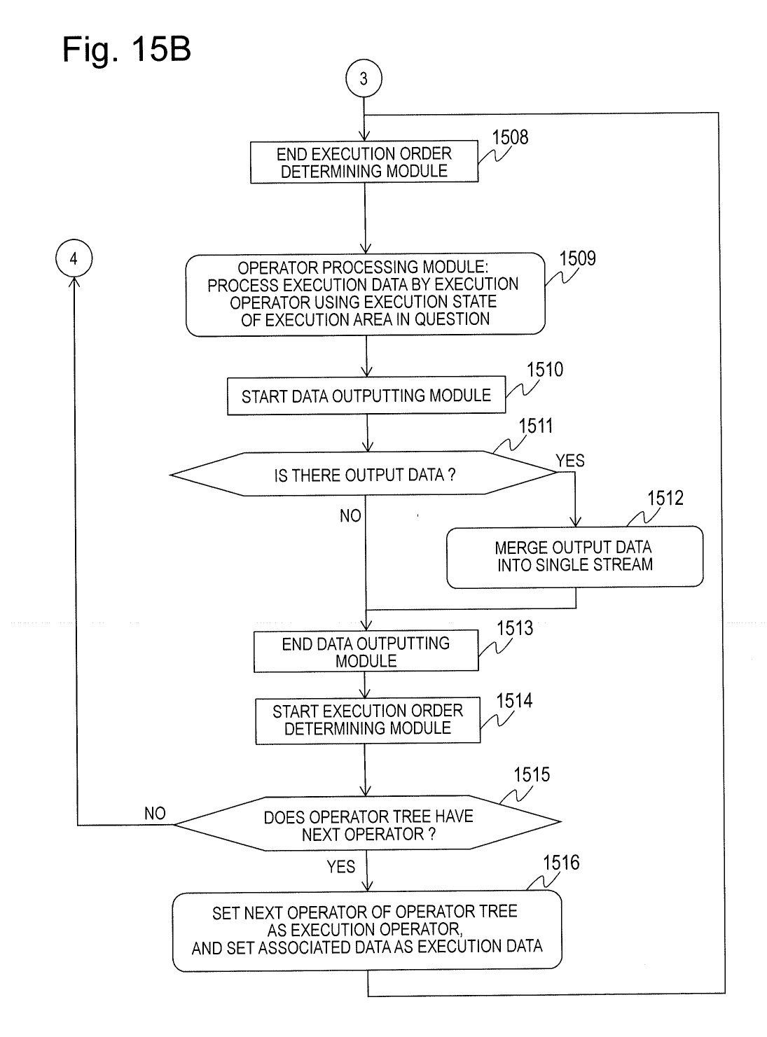

FIGS. 15A and 15B are flow charts illustrating an example of processing of the data executing module 112. The execution of this processing can be started when the input stream 214 is received from the data inputting module 110.

First, the execution order determining module 217 (1501) obtains the input data 213 from the input stream 214 which has been output by the data inputting module 110. The execution order determining module 217 uses the data set key value 402 for an input stream of the input data 213 to extract an execution area name that is associated with the data set key value 402 for an input stream from the execution area name reference table 215, and sets an execution area having the extracted name as the execution area of a data set to which the input data 231 belongs. At this point, the execution order determining module 217 may check whether or not pieces of the input data 213 are arranged in chronological order in the same data set (the input stream 214).

The execution order determining module 217 next determines whether or not the execution area name reference table 215 contains the execution area associated with the data set key value 402 for an input stream of the input data 213 (1503).

In the case where the execution area associated with the data set key value 402 for an input stream is found in the table, the execution order determining module 217 stores the input data in the stream data storage queue 221 of the execution area to which the input data 213 belongs (1505).

When it is determined in Step 1503 that the execution area name reference table 215 does not contain the data set key value 402 for an input stream of the input data 213, on the other hand, the execution order determining module 217 generates an execution area that is associated with this data set key value 402 for an input stream, and adds this data set key value 402 for an input stream and the execution area name of the generated execution area to the execution area name reference table 215 (1504). The execution area generated by the execution order determining module 217 is set as the execution area of the data set to which the input data 213 belongs, and the input data 213 is stored in the stream data storage queue 221 of this execution area (1505). The ignition time reference table 222 of this execution area is an empty table devoid of entries such as the entry 1007. The execution state 223 of this execution area, too, is an empty area devoid of entries such as the entries 1011 and 1012. The ignition time table 222 and the execution state 223 are updated by the operation processing module 227.

In the case where the input data 706 is obtained from the input stream 214 of FIG. 9, for example, the execution order determining module 217 extracts “execution area B” from the execution area name reference table 215 (see FIG. 5) as the execution area of the data set key value 402 for an input stream, namely, “Sato Building”, because the data set key value 402 for an input stream of the input data 706 is “Sato Building”. The execution order determining module 217 stores the input data 706 in the stream data storage queue 1015 of the execution area B 219 of FIG. 10B. Similarly, because the data set key value 402 for an input stream of the input data 707 is “Tanaka residence” as illustrated in FIG. 16A, the input data 707 is stored in the stream data storage queue 1002 of the execution area A 218 of FIG. 10A. The input data 708 whose data set key value 402 for an input stream is “Sato Building” is stored in the stream data storage queue 1015 of the execution area B 219 of FIG. 10B.

Dummy data may be input instead. The execution order determining module 217 in this case generates an execution area that is associated with the data set key value 402 for an input stream of the dummy data, and adds the data set key value 402 for an input stream of the dummy data and the execution area name of the generated execution area to the execution area name reference table 215. Alternatively, dummy data that has an end flag may be input so that the execution order determining module 217 can execute the following processing. In an example of this processing, the execution order determining module 217 first reads the end flag. When the end flag has a given value and there is an execution area that is associated with the data set key value 402 for an input stream of the dummy data, the execution order determining module 217 removes the execution area and deletes the data set key value 402 for an input stream of the dummy data and the execution area name 502 of the removed execution area from the execution area name reference table 215.

The execution order determining module 217 next refers to the stream data storage queue 221 in the execution area of the data set to which the input data 213 belongs, and compares the time of data at the head of the queue (in the case of a query for processing data of a plurality of input streams, times of pieces of data at the head of a plurality of stream data storage queues) against the ignition time of each operator in the ignition time reference table 222. In the case where the comparison reveals that the stream data storage queue 221 contains data having the earliest time (1506), this data is set as execution data. When the execution data 224 is data at the head of the stream data storage queue 221, the execution order determining module 217 sets the first operator of the operator tree 228 as an execution operator. In the case of data whose operator ignition time is the current time, the execution order determining module 217 sets the operator associated with this ignition time as an execution operator (1507), and ends the processing of the execution order determining module 217 (1508).

In the case where the stream data storage queue 221 does not contain data having the earliest time in Step 1506, the execution order determining module 217 goes back to Step 1502 to obtain the next input data 213 from the input stream 214, and repeats the same processing as above.

For example, when the execution order determining module 217 stores the input data 706 in the stream data storage queue 1015 of the execution area B 219, the execution order determining module 217 compares a time “7:59” of the input data 706 against an ignition time “8:00” of the operator RANGE (1020) which is stored in the ignition time reference table 222. Because the time “7:59” of the input data 706 is earlier than the ignition time, the input data 706 is set as the execution data 224 and the first operator 601 of the operator tree 228 (FIG. 6) is set as the execution operator 226 in a command issued to the operator processing module 227.

In the operator processing module 227, the execution operator 226 processes the execution data 224 with the use of the execution state 223 in an execution area that is associated with the data set key value 402 for an input stream of the execution data 224 (1509).

The data executing module 112 next performs processing of the data outputting module 230 for outputting the processing result of the execution operator 226 (1510). The data outputting module 230 first determines whether or not there is output data with respect to the processing result of the execution operator 226 (1511). When there is no output data, the data outputting module 230 proceeds to Step 1513 and ends the processing of the data outputting module 230. When there is output data, on the other hand, the data outputting module 230 executes Step 1512.

In the case where the processing result of the execution operator 226 is received as output data by the receiving server 117 or the input data receiving module 207, the data outputting module 230 merges the output data 229 which is the processing result of the execution operator 226 into a single stream instead of merging on an execution area-by-execution area basis (1512). The data outputting module 230 merges a plurality of pieces of output data 229 and outputs the merged data as the output stream 231. After the processing of the data outputting module 230 is finished (1513), the data executing module 112 resumes the processing of the execution order determining module 217 (1514).

The execution order determining module 217 determines in Step 1515 whether or not the operator tree 228 has the next operator (1515). The execution order determining module 217 proceeds to Step 1516 when the operator tree 228 has the next operator and, when the operator tree 228 does not have the next operator, returns to Step 1506 to repeat the processing described above. The execution order determining module 217 determines the next operator of the operator tree 228 as the execution operator 226 in Step 1516, and then returns to Step 1508 to repeat the processing described above.

In short, as long as there is a next operator in the operator tree 228 (1515), the data executing module 112 continues the processing by setting the next operator as the execution operator 226, setting as the execution data 224 the next data that belongs to the same data set (that has the same data set key value 402 for an input stream) and having the same time as the processed execution data 224, and using the execution state 223 in an execution area that is associated with the data set key value 402 for an input stream of the execution data 224.

When there is no more next operator in the operator tree 228 in Step 1515, the data executing module 112 extracts executable data in Step 1506, and processes the extracted data in the manner described above. In the case where executable data cannot be extracted in 1506, the data executing module 112 obtains input data from the input stream in 1502, and operates in the manner described above.

For instance, after operator processing is conducted with the input data 706 set as the execution data 224 and the operator RANGE (601) set as the execution operator 226 as illustrated in FIG. 16B, the result of this processing which is denoted by 1603 is set as the execution data 224 and the next operator GROUP BY (602) is set as the execution operator 226 to conduct operator processing. The data executing module 112 further sets the processing result of the operator GROUP BY (602) which is denoted by 1604 as the execution data 224 and sets the next operator ISTREAM (603) as the execution operator 226 to conduct operator processing. The result of this processing which is denoted by 1203 is stored as output data in the output stream 231 to be transmitted to the receiving server 117. There is no more next operator in the operator tree 228 (FIG. 6), and the data executing module 112 subsequently executes operator processing with the input data 708 as the execution data 224.

The first embodiment described above is one way to carry out this invention which is based on operator scheduling disclosed in Patent Literature 4, and this invention can be carried out by various other methods. For instance, instead of separating the execution areas 218 and 219 by the data set key value 402 for an input stream, the ignition time reference tables 1004 and 1017 and the stream data storage queues 1002 and 1015 may be separated by the data set key value 402 for an input stream so that a separate execution state is set for each operator by defining the execution state in a query without separating the execution states 1008 and 1021 by the data set key value for an input stream.

The first embodiment shares a commonality with Patent Literature 4 in that the execution order determining module 217 refers to the ignition time reference table 222 and the stream data storage queue 221. However, the first embodiment differs from Patent Literature 4 in that the execution area name reference table 215, the execution area name 216, and the execution areas 218 and 219 are referred to, which is a configuration unique to this invention. Another unique configuration of this invention is that the data set key reading module 211, the data set key 205, the partial chronological partition processing module 209, the data set conversion table 210, and the data outputting module 230 are included in the first embodiment unlike Patent Literature 4.

As described above, the data set conversion table 210 is generated in this invention from the data set key 205 received by the stream data processing server 108, which processes the input data 201 to input data 203 each containing a time (hereinafter simply referred to as input data). The data set conversion table 210 has two keys, the data set key value 402 for an input stream (the first key) which defines the type (group) of input data to be processed in the same execution area, and the data set key value 401 for input data (the second key) which defines the item of input data to be input organized in chronological order. The query registering module 111 receives the stream and query definition 206 to generate the operator tree 228, and outputs the operator tree 228 to the data executing module 112.

The data inputting module 110 of the stream data processing server 108 generates the input stream 214 by grouping together pieces of input data by the data set key value 401 for input data and then sorting the grouped input data in chronological order for each data set key value 402 for an input stream.

The data executing module 112 sets the execution areas 218 and 219 in the memory 109 as areas for processing input data for each data set key value 402 for an input stream in the data set conversion table 210. In other words, an execution area is generated for each group (data set) of input data classified by the item of the data set key value 402 for an input stream.

The data executing module 112 determines an operator associated with input data so that the operator executes given query processing in the execution area, which is provided for each type (data set) of input data included in the input stream 214. The data executing module 112 then outputs the output stream 231.

Through the processing described above, the input data 213 can be processed by operators in the execution areas 218 and 219 provided in the memory 109 separately for different values of the data set key value 402 for an input stream which is the first key. This means that processing by an operator can be conducted while maintaining chronological order only for pieces of input data in one piece of stream data that have the same data set key value 402 for an input stream, which is the first key. Processing by an operator for pieces of input data that have different values as the data set key value 402 for an input stream, which is the first key, can thus be executed in each of the execution areas 218 and 219 of the data executing module 112 without waiting for input data that has not arrived in time. The processing latency is accordingly prevented from increasing while maintaining processing consistency.

In short, by sorting input data in chronological order for each data set before the data executing module 112 executes a query, the data inputting module 110 can determine the execution order of a plurality of pieces of input data received from the plurality of sending servers 101 to 103 the same way that the execution order is determined for data sets within one server.

This eliminates the need to use a control packet for the progress of time and the need to perform data discarding or similar processing as in the examples of the related art even when non-chronological input data is received, and prevents the processing latency from increasing while maintaining consistency in data processing. This also eliminates the need to secure a memory area while waiting for a control packet as in the examples of the related art, and therefore prevents the memory cost from increasing.

In addition, the data executing module 112 can dynamically generate execution areas in the memory 109 during stream data processing. In other words, even when stream data processing is started, the stream data processing server 108 does not generate an execution area until input data that corresponds to the data set key value 402 for an input stream is actually received. The stream data processing server 108 of this invention thus secures only execution areas necessary for stream data processing in the memory 109, and the increase in memory cost in the examples of the related art is therefore prevented in this invention.

### Second Embodiment

A second embodiment of this invention is described next with reference to the drawings. The second embodiment discusses a method of carrying out this invention based on round robin operator scheduling that is disclosed in Non-Patent Literature 3.

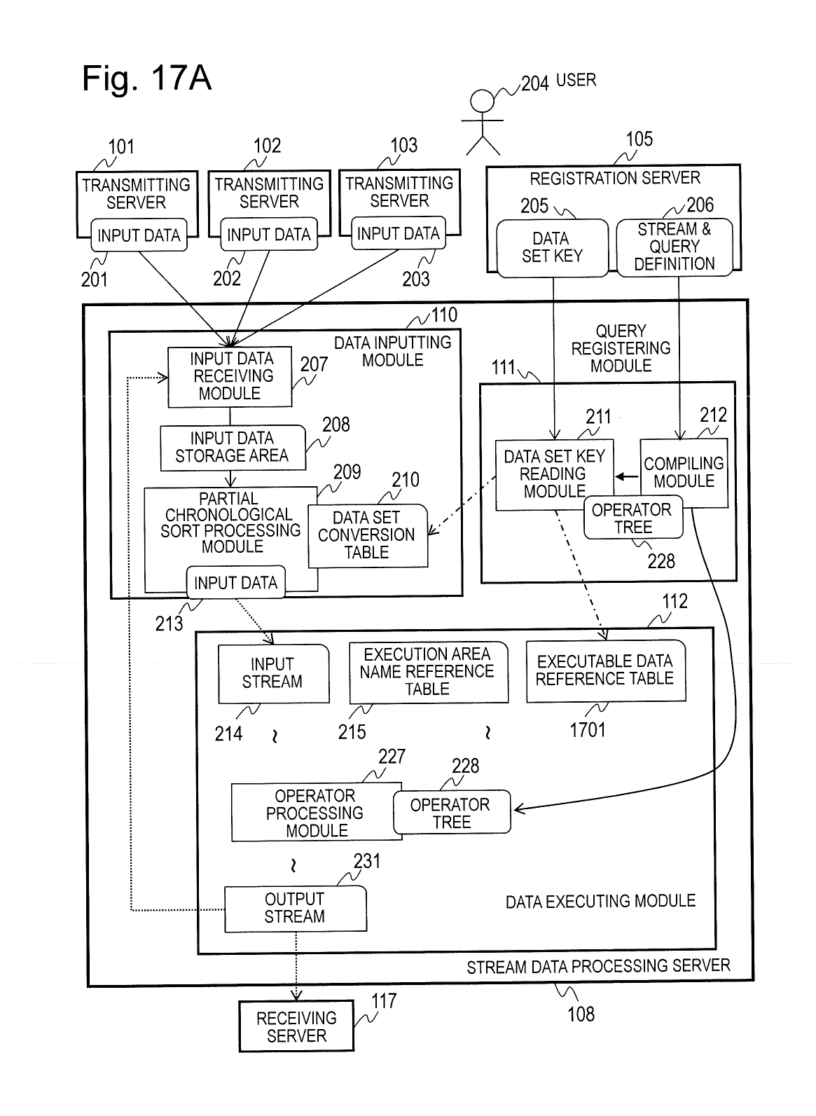

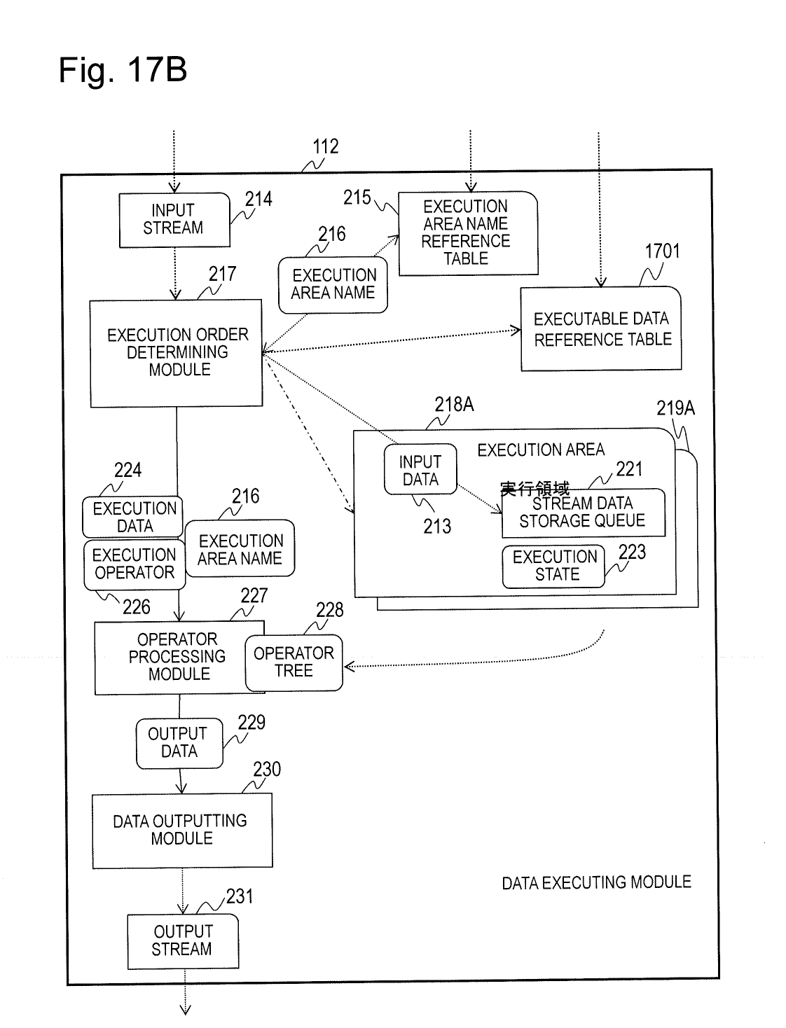

FIGS. 17A and 17B are block diagrams of the second embodiment. FIG. 17A is a block diagram of a computer system that illustrates input/output relations of the stream data processing server 108. FIG. 17B is a detailed block diagram of the data executing module 112 of the stream data processing server 108.

The second embodiment differs from the first embodiment in that the data set key reading module 211 of the query registering module 111 generates an executable data reference table 1701 from the data set key 205 and from the operator tree 228 generated by the compiling module 212. The data inputting module 110 executes the same processing that is executed in the first embodiment. The execution order determining module 217 of the data executing module 112 uses the executable data reference table 1701 to extract the execution data 224 and the execution operator 226. As illustrated in FIG. 17B, execution areas 218A and 219A differ from the execution areas of the first embodiment in that the ignition time reference table is not included. The operator processing module 227 and data outputting module 230 of the data executing module 112 execute the same processing that is executed in the first embodiment. Components in the second embodiment that are the same as those in the first embodiment are denoted by the reference symbols that are used in FIGS. 2A and 2B.

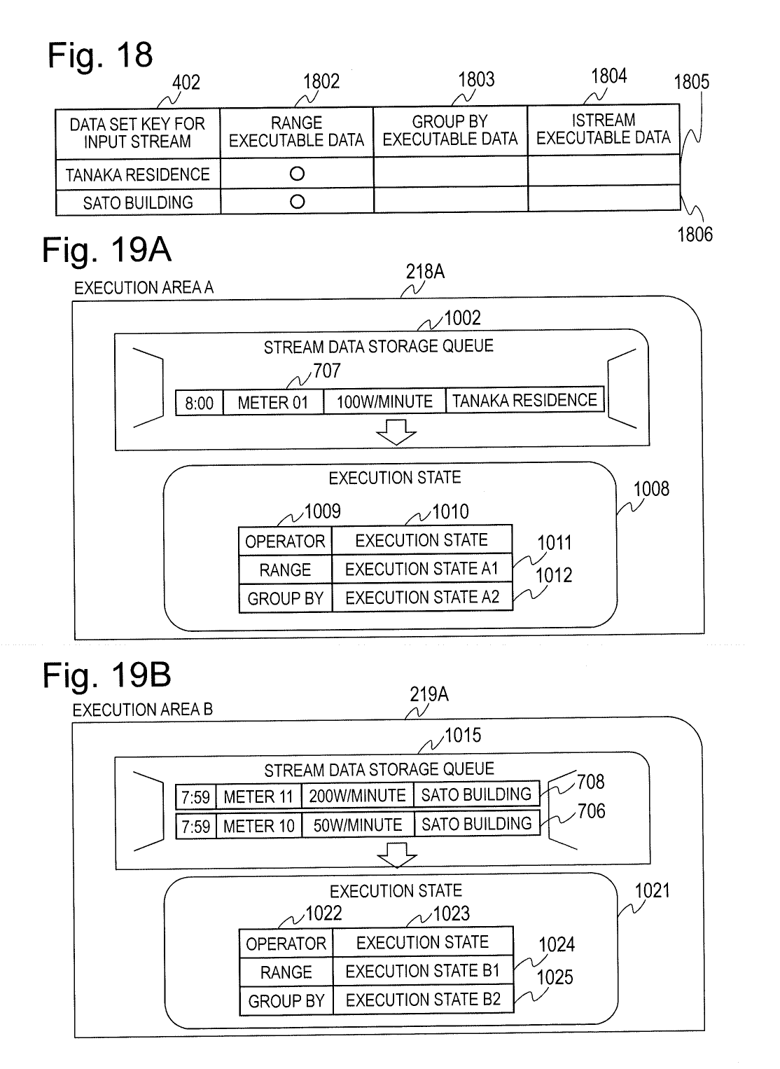

FIG. 18 is an explanatory diagram illustrating an example of the executable data reference table 1701. The executable data reference table 1701 is generated by the query registering module 111 and updated by the data executing module 112. The executable data reference table 1701 shows, for each operator of the operator tree 228 and for each data set key value 402 for an input stream, whether there is executable data or not. In FIG. 18, “Tanaka residence” 1805 and “Sato Building” 1806 are registered as the data set key value 402 for an input stream, and whether there is executable data or not is indicated for each of an operator RANGE 1802, an operator GROUP BY 1803, and an operator ISTREAM 1804 by whether or not a flag “∘” is stored.

FIGS. 19A and 19B are block diagrams illustrating an example of the execution areas 218A and 219A. Unlike the execution areas 218 and 219 of the first embodiment, the execution areas 218A and 219A in the second embodiment do not include the ignition time reference tables 1004 and 1017, and respectively include the stream data storage queues 1002 and 1015 and the execution states 1008 and 1021.

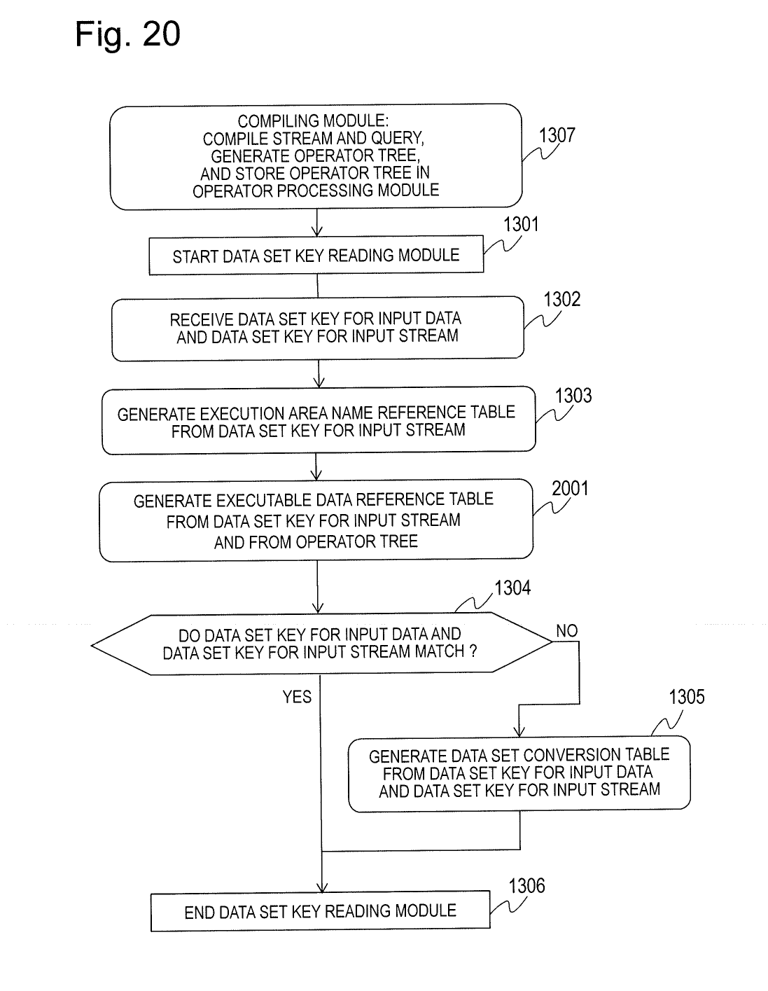

FIG. 20 is a flow chart illustrating an example of processing of the query registering module 111. This flow chart is obtained by adding Step 2001 to the flow chart of FIG. 13, which is described above in the first embodiment, between Step 1303 and Step 1304, and the rest of the processing is the same as in FIG. 13. A duplicate description on the same processing as the one in FIG. 13 of the first embodiment is omitted from the following description.

In processing of the query registering module 111 of the second embodiment, unlike the first embodiment, the executable data reference table 1701 is generated from the data set key 205 for an input stream received from the registration server 105, which transmits a user's input, and from operators included in an operator tree (which is generated by the compiling module) (2001). The generated executable data reference table 1701 may contain data such as data of the entries 1805 and 1806 of FIG. 18, or may be an empty table devoid of data. The rest of the processing executed when registering a query is the same as in the first embodiment (1301 to 1307).

Processing of the data inputting module 110 is the same as in the first embodiment.

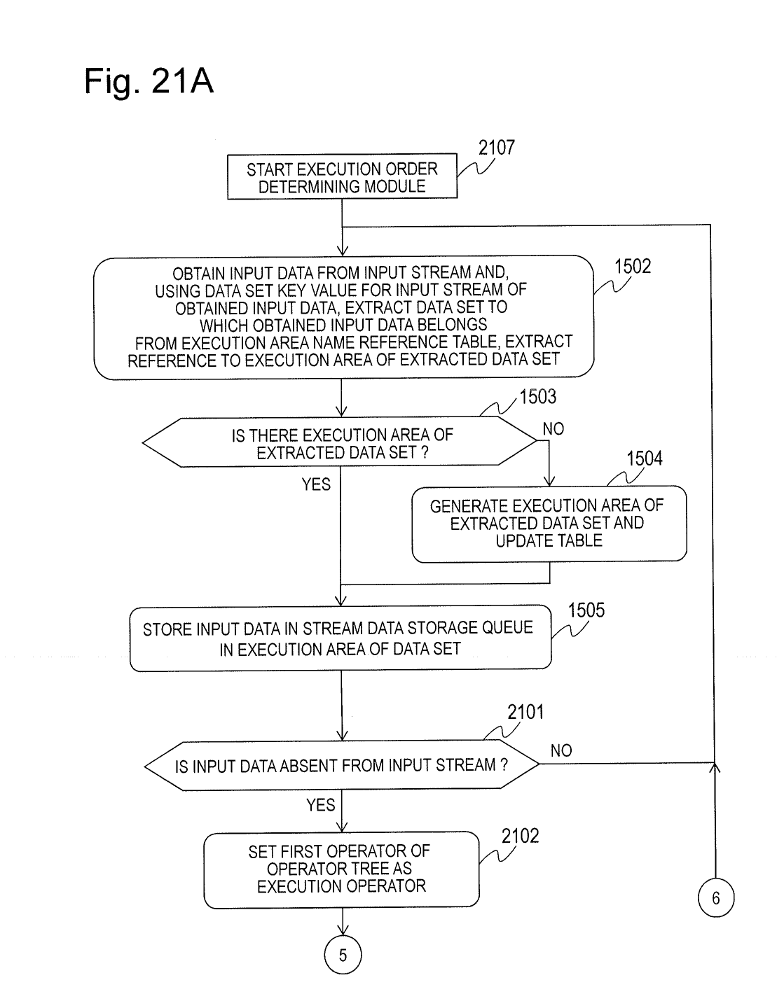

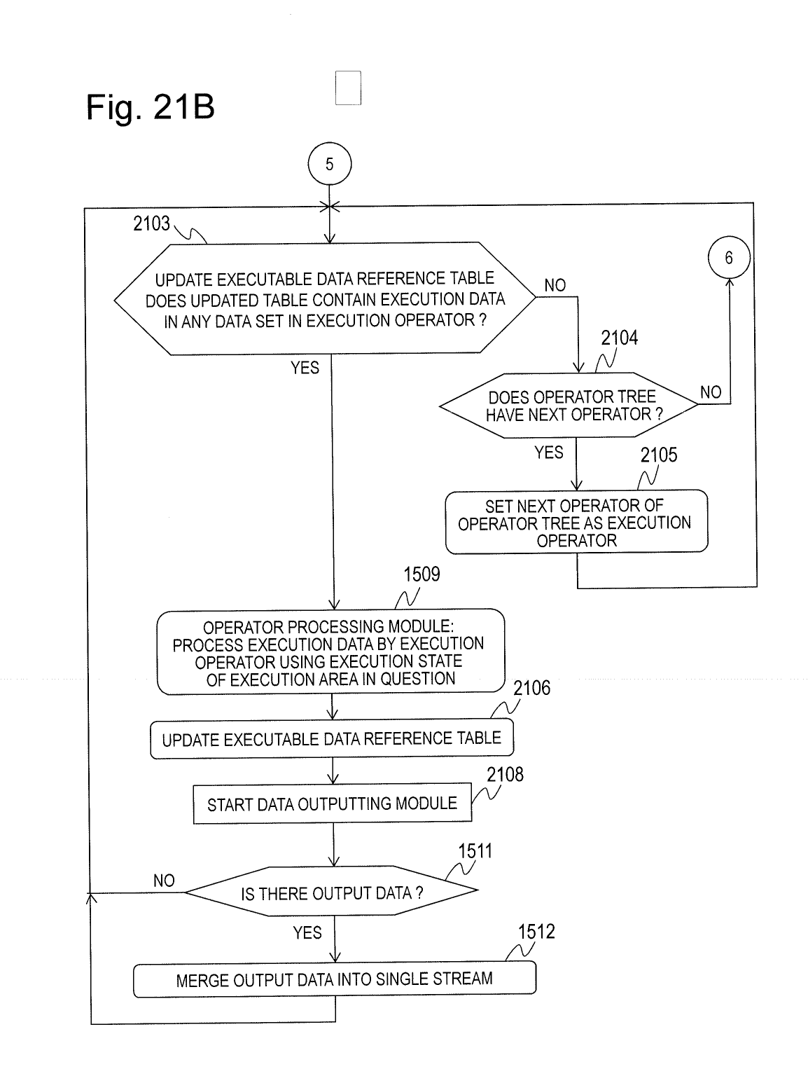

FIGS. 21A and 21B are flow charts illustrating an example of processing of the data executing module 112. The processing of FIGS. 21A and 21B is processing that is conducted in the data executing module 112 in place of the processing of FIGS. 15A and 15B of the first embodiment.

In the processing of the data executing module 112, the execution order determining module (2107) keeps storing input data in a stream data storage queue following the procedures of 1502 to 1505 (which are the same as those in the first embodiment), as long as there is input data in the input stream 214 (2101).

In Steps 1502 to 1505, the execution order determining module 217 stores the input data 213 of the input stream 214 in the stream data storage queues 221 of the execution areas 218A and 219A, which are provided separately for each different data set key value 402 for an input stream, in the same manner as in FIG. 15A of the first embodiment.

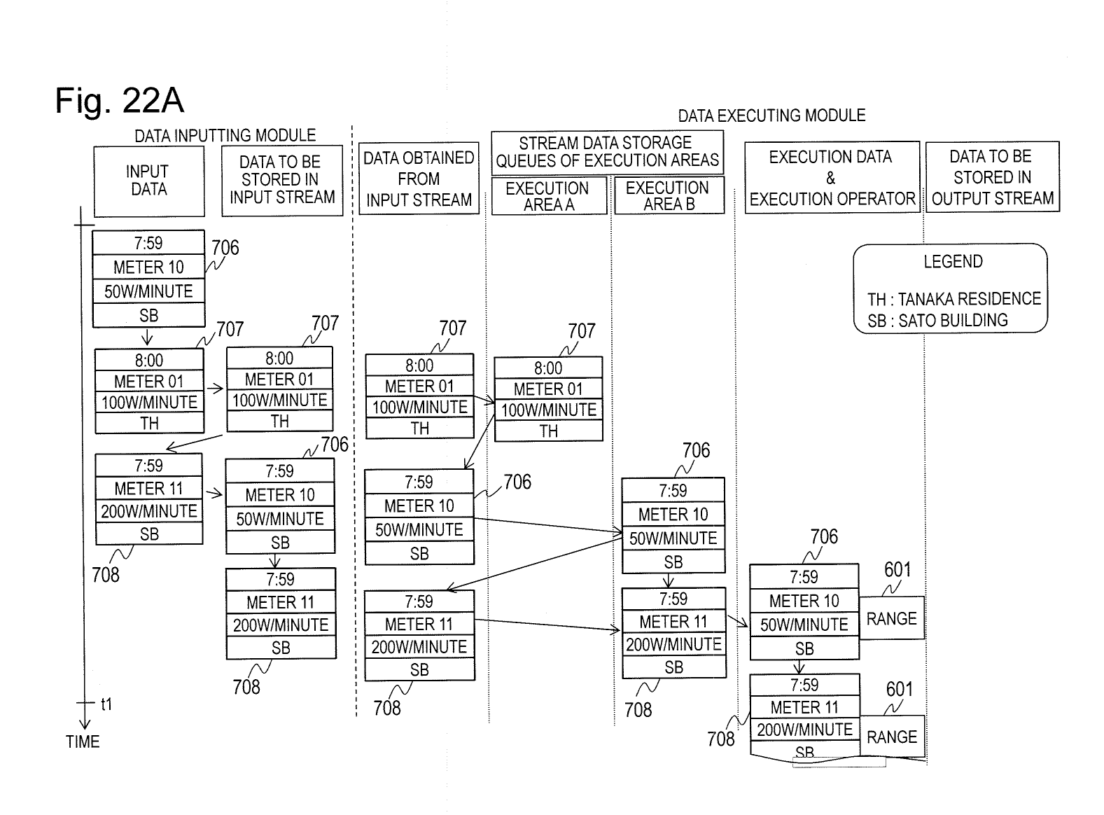

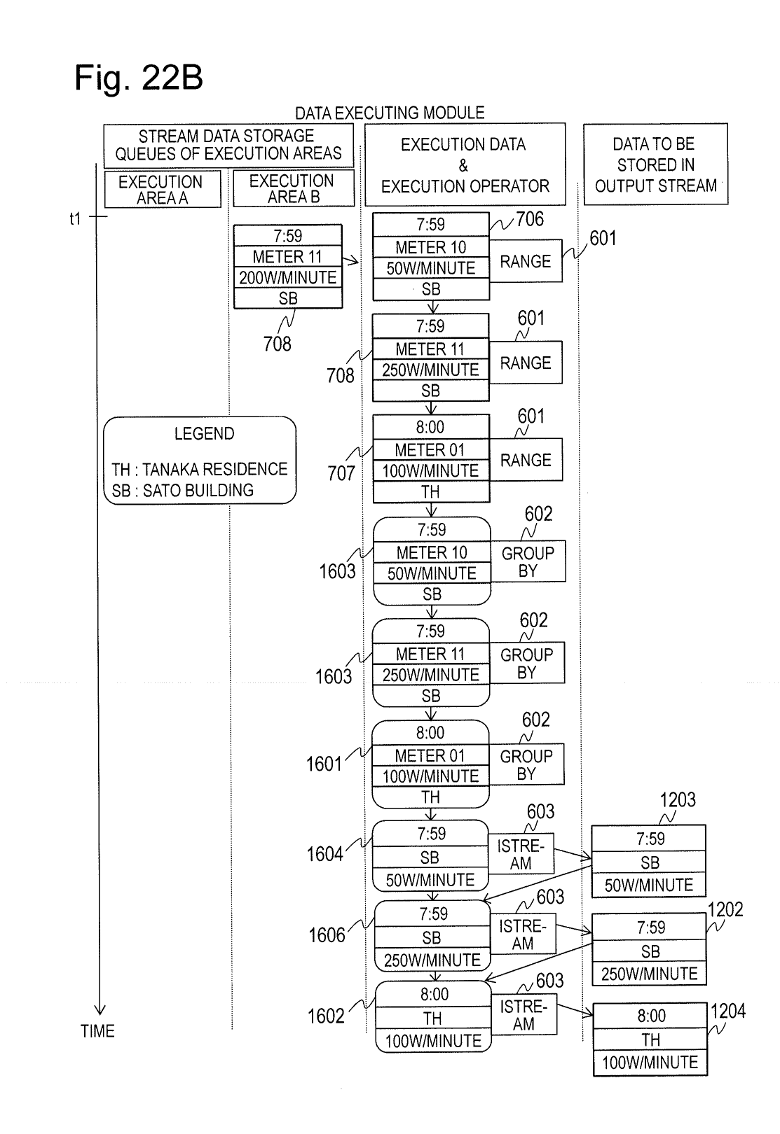

FIGS. 22A and 22B are time charts of the data inputting module 110 and the data executing module 112. Unlike the first embodiment, the data executing module 112 obtains the data 707, the data 706, and the data 708 in succession from the input stream 214, which is output by the data inputting module 110, through the processing of Step 2101. The data executing module 112 stores the input data 707 in the stream data storage queue 1002 of the execution area A, and stores the input data 706 and the input data 708 in the stream data storage queue 1015 of the execution area B.

When there is no more input data 213 in the input stream 214 (2101 of FIG. 21A), the execution order determining module 217 of the data executing module 112 sets the first operator of the operator tree 228 as the execution operator 226 (2102 of FIG. 21A).

The data executing module 112 then compares the time of data at the head of the stream data storage queue 221 in the execution area of a data set to which the obtained input data 213 belongs (in the case of a query for processing data of a plurality of input streams, times of pieces of data at the head of a plurality of stream data storage queues, here, queues 1002 and 1015), and selects a stream data storage queue that contains data having the earliest time. The data executing module 112 updates the executable data reference table 1701 (FIG. 18) with respect to the input data 213 of the selected stream data storage queue by adding the “∘” flag to execution operator items in the executable data reference table 1701 that are associated with the data set (the data set key value 402 for an input stream) of the input data.

Specifically, the execution order determining module 217 extracts the input data 213 whose head data has the earliest time out of pieces of the input data 213 in the stream data storage queues 1002 and 1015, and updates the executable data reference table 1701 by writing a value that indicates that data is executable (for example, “∘”) in an entry of the executable data reference table 1701 that is associated with the extracted input data 213 and the operator tree 228.

The execution order determining module 217 refers to the updated executable data reference table 1701 and, in the case where executable data is found in one of the data sets (2103 of FIG. 21B) for the execution operator 226, the execution operator 226 processes the execution data 224 with the use of the execution state 223 in the execution area of this data set (1509 of FIG. 21B).

When there is no more data that can be executed by the execution operator 226 in this data set, the execution order determining module 217 resets the associated entry of the executable data reference table (FIG. 18) by deleting the “∘” flag from the associated entry (2106 of FIG. 21B).

In the case where the result of the processing of the execution operator 226 is to be obtained as output data by the receiving server 117 or the input data receiving module 207 (1511), the execution order determining module 217 merges the processing result into a single stream as in the first embodiment (1512).

The execution order determining module 217 repeats the processing of Steps 2103 to 1512 described above. In the case where the execution data 224 cannot be found in Step 2103, the execution order determining module 217 executes the processing of Step 2103 with the next operator of the operator tree 228 set as the execution operator 226 (2104). When there is no more next operator in the operator tree 228 in Step 2104, the execution order determining module 217 returns to Step 1502 to obtain the input data 213 from the input stream 214, and processes the obtained input data 213 in the manner described above.

For example, the stream data storage queues 221 of FIGS. 19A and 19B are stream data storage queues 1002 and 1015 storing the input data 707, the input data 706, and the input data 708. After storing the input data 213 described above in the relevant stream data storage queue 221, the execution order determining module 217 of the data executing module 112 determines, as the execution operator 226, the operator RANGE 601 which is the first operator of the operator tree 228 (FIG. 6) as illustrated in FIGS. 22A and 22B. The execution order determining module 217 then refers to the executable data reference table 1701 (FIG. 18) to find out that a data set “Sato Building” is executable (the flag “∘” is stored) by the operator RANGE 601. The input data 706 is therefore set as execution data as illustrated in FIGS. 22A and 22B. After the execution data 706 is processed in the execution area B by the operator RANGE 601, which is the execution operator 226, the execution order determining module 217 updates the executable data reference table 1701 by deleting (resetting) the flag “∘” of the operator RANGE with respect to the data set “Sato Building” from the executable data reference table 1701, and setting the flag “∘” to the operator GROUP BY with respect to this data set.

As illustrated in FIGS. 22A and 22B, the execution order determining module 217 subsequently sets the data 708 of the data set “Sato Building” as execution data, executes the data 707 of a data set “Tanaka residence” next, and updates the executable data reference table 1701 in the manner described above.

After the execution of the operator RANGE 601, there is no more data that can be executed by the operator RANGE 601. The execution order determining module 217 therefore sets the next operator in the operator tree 228 (FIG. 6), namely, the operator GROUP BY 602, as the execution operator 226. The execution order determining module 217 similarly selects execution data 1603, execution data 1605, and execution data 1601 to be processed by the operator GROUP BY 602, and updates the executable data reference table 1701 in the manner described above.

Lastly, the operator ISTREAM 603 processes execution data 1604, execution data 1606, and execution data 1602, and the execution order determining module 217 stores the results of the processing in the output stream as output data 1203, output data 1202, and output data 1204 as in the first embodiment.

The processing described above which is performed by the data executing module 112 is one of the round robin operator scheduling methods disclosed in Non-Patent Literature 3 that uses the same operator as the execution operator 226 to process data as long as the execution data 224 is found for the operator. Other scheduling methods than the one described above may also be implemented in this invention, such as a scheduling method in which the same operator is used as the execution operator 226 for a given period of time or for a given number of times, and a scheduling method in which the execution operator is selected at random from among operators for which executable data can be found.

The second embodiment shares a commonality with Non-Patent Literature 3 in that the execution order determining module 217 refers to the stream data storage queue 221, but differs from Non-Patent Literature 3 in that the execution area name reference table 215, the execution area name 216, the execution areas 218 and 219, and the executable data reference table 1701 are referred to. A feature of the second embodiment in terms of configuration is that, unlike Non-Patent Literature 3, the stream data processing server 108 includes the data set key reading module 211, the data set key 205, the partial chronological partition processing module 209, the data set conversion table 210, and the data outputting module 230.

### Third Embodiment

A third embodiment is described next with reference to the drawings. Unlike the first embodiment and the second embodiment, the third embodiment does not change the stream data processing engine of the examples of the related art (corresponds to the data executing module 112 in this invention) and yet attains the same effect.

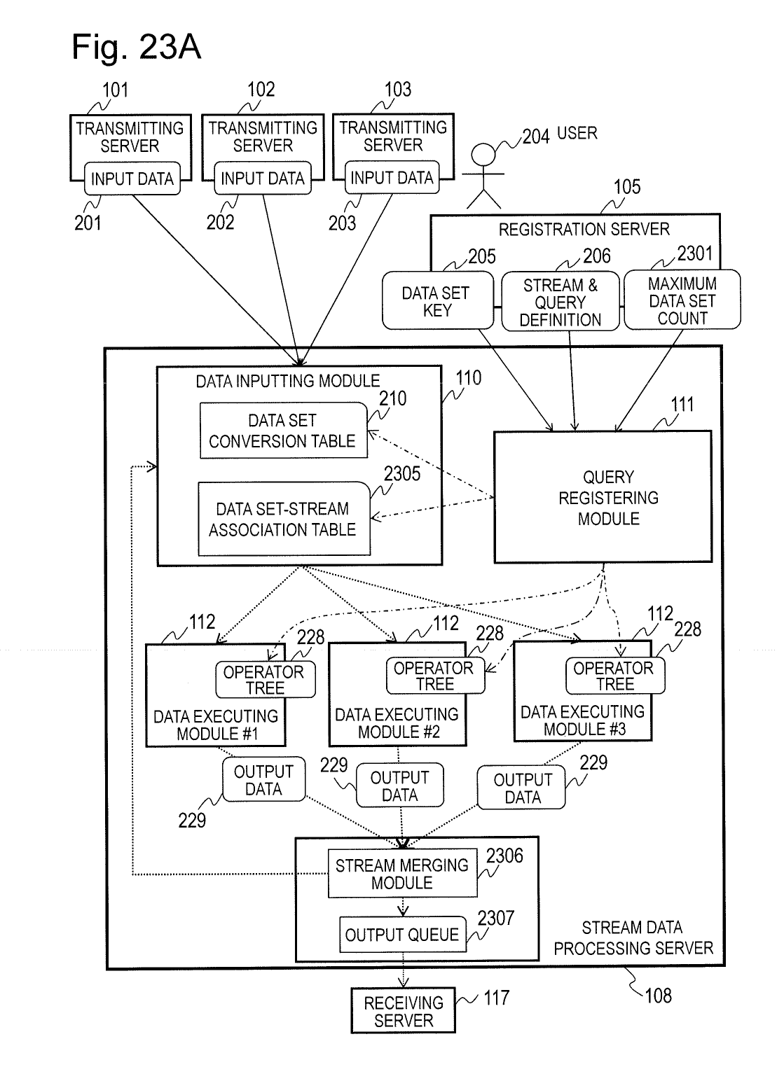

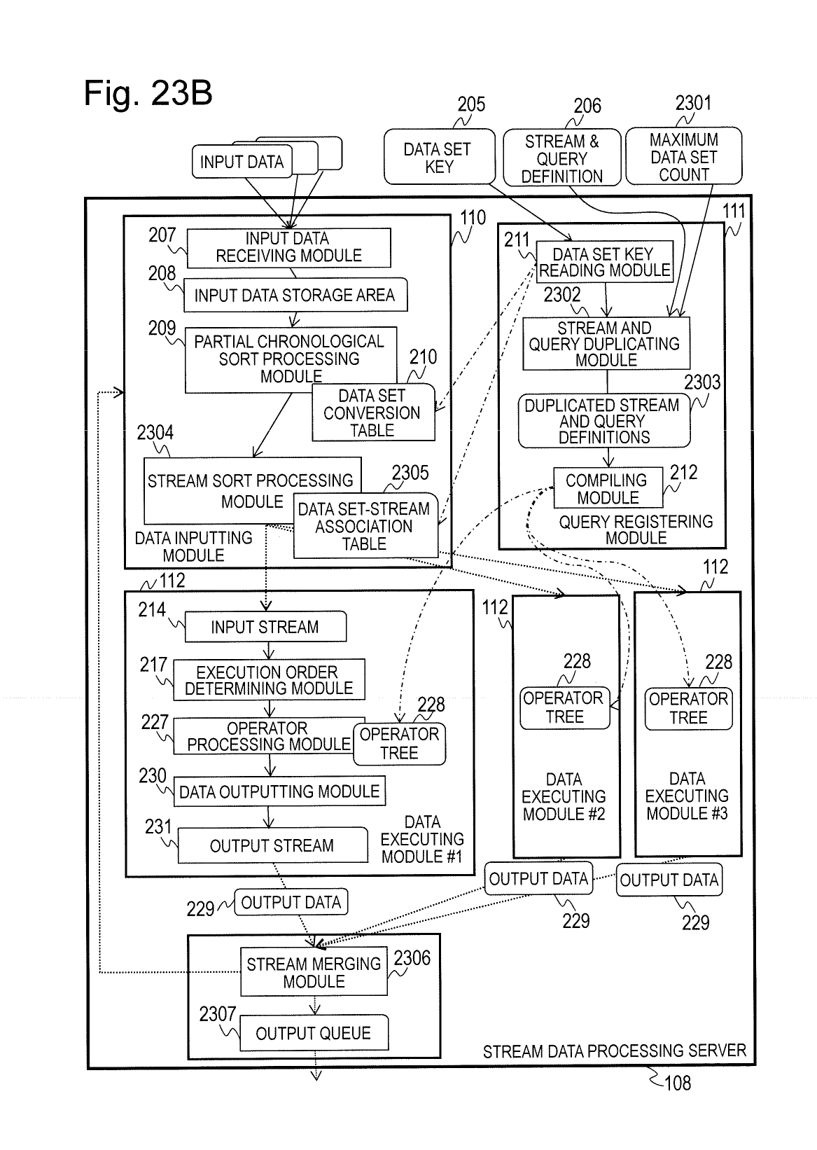

FIGS. 23A and 23B are block diagrams illustrating a computer system of the third embodiment. FIG. 23A is a block diagram illustrating input/output relations of the stream data processing server 108. FIG. 23B is a detailed block diagram of the stream data processing server 108.

In the third embodiment, the user 204 specifies a maximum data set count 2301 of pieces of data processed in the query registering module 111 unlike the first embodiment and the second embodiment, and the specified maximum data set count 2301 of pieces of data processed is transmitted from the registration server 105 to the stream data processing server 108.

The query registering module 111 uses a stream and query duplicating module 2302 to receive the data set key 205, the stream and query definition 206, and the maximum data set count 2301 from the registration server 105, and to generate duplicate stream and query definitions 2303. The query registering module 111 uses the compiling module 212 to generate a plurality of operator trees 228 from the duplicate stream and query definitions 2303, and the operator trees 228 are respectively transferred to a plurality of data executing modules 112. While FIGS. 23A and 23B illustrate an example in which three data executing modules #1 to #3 constitute the plurality of data executing modules 112, the stream data processing server 108 can include any number of data executing modules 112.

Unlike the first embodiment and the second embodiment, the data inputting module 110 stores input data partially sorted in chronological order by the partial chronological partition processing module 209 in the input streams 214 of the plurality of data executing modules 112 that are indicated by a data set-stream association table 2305.

The input streams 214 are processed by the plurality of data executing modules (#1 to #3) 112 in the same manner that is used in conventional stream data processing systems, and pieces of the output data 229 which are the results of the processing are output to be stored in the output streams 231.

Lastly, the pieces of the output data 229 are obtained by a stream merging module 2306 from the output streams 231 of the plurality of data executing modules 112, and are stored in an output queue 2307.

The pieces of the output data 229 stored in the output queue 2307 are transmitted to the receiving server 117 or the input data receiving module 207.

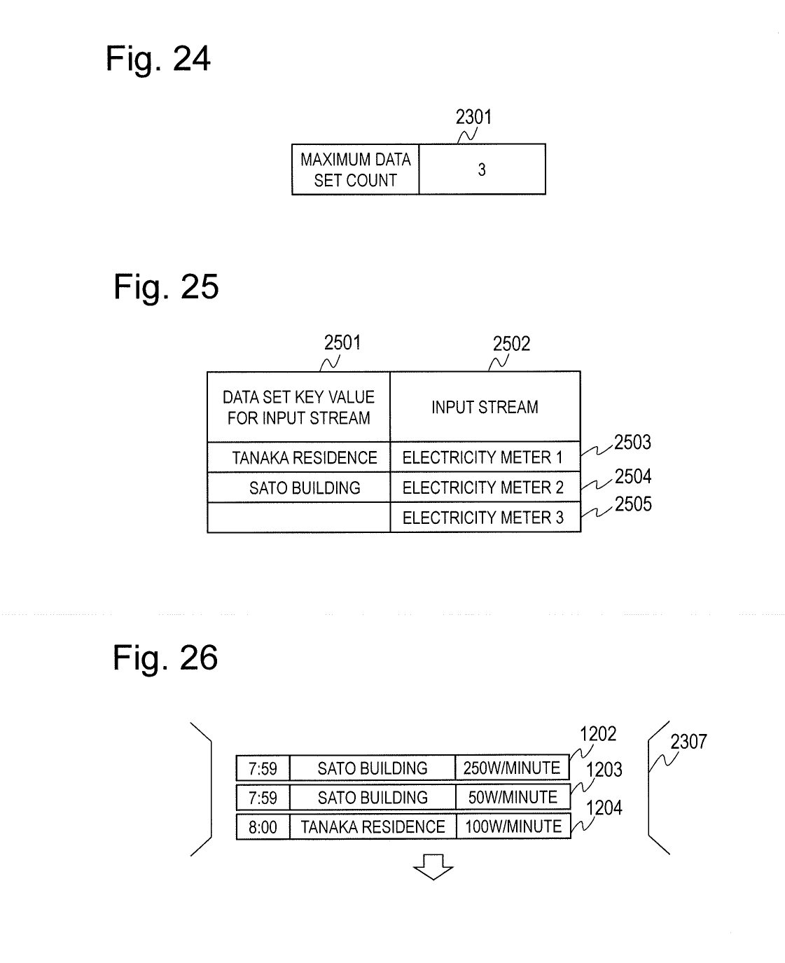

FIG. 24 illustrates an example of the maximum data set count 2301. The maximum data set count 2301 registered in the query registering module 111 indicates how many values can be set as the data set key value 402 for an input stream. The maximum data set count 2301 in FIG. 24 is 3 and, because the data set key for an input stream is “installed location”, means that the number of installed locations is 3 at maximum. The maximum data set count 2301 indicates the number of the input streams 214 of the data executing module 112 as described later.

FIG. 25 illustrates an example of the data set-stream association table 2305 of the data inputting module 110. The data inputting module 110 in the third embodiment generates, for each data set key value for an input stream, different input streams 214 respectively associated with the plurality of data executing modules, #1 to #3, and stores input data in the input streams 214. The data set-stream association table 2305 shows the association relation between a data set key value 2501 for an input stream and an input stream 2502 where input data that has the data set key value for an input stream is stored. For example, an entry 2503 in FIG. 25 indicates that input data having “Tanaka residence” as the data set key value 2501 for an input stream is stored in an input stream “electricity meter 1”. An entry 2504 indicates that input data having “Sato Building” as the data set key value 2501 for an input stream is stored in an input stream “electricity meter 2”. An entry 2505 indicates that there is no input data to be stored in an input stream “electricity meter 3”. In the illustrated example, the input stream “electricity meter 1” corresponds to the input stream 214 of the data executing module #1, the input stream “electricity meter 2” corresponds to the input stream 214 of the data executing module #2, and the input stream “electricity meter 3” corresponds to the input stream 214 of the data executing module #3.

FIG. 26 illustrates an example of the output queue 2307. The output queue 2307 is a queue for storing the output data 229 to be transmitted to the receiving server 117 or the input data receiving module 207. The output queue 2307 in the example of FIG. 26 stores output data 1202 to output data 1204.

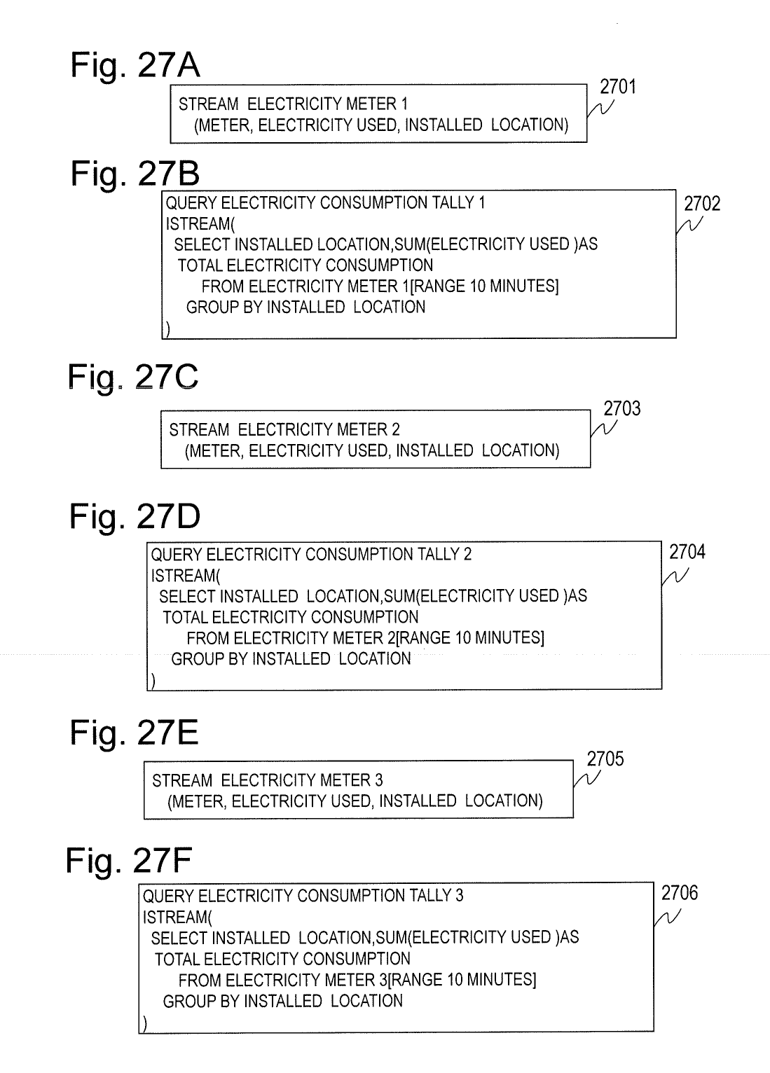

FIGS. 27A to 27F illustrate an example of the duplicate stream and query definitions 2303 of the query registration module 111. The duplicate stream and query definitions 2303 are stream definitions and query definitions that are obtained by duplicating, in the stream and query duplicating module 2302, the stream definition and query definition of the stream and query definition 206 (FIGS. 3A and 3B) specified by the user using the registration server 105, and changing the stream name and query name after the duplication.

FIGS. 27A, 27C, and 27E illustrate streams 2701, 2703, and 2705 for the electricity meters 1 to 3 of the data set-stream association table 2305 of FIG. 25. Definitions of the streams are stream definitions obtained by duplicating three copies of the electricity meter stream definition 301 of FIG. 3A in the stream and query duplicating module 2302, and giving each of the three copies a changed stream name.

FIGS. 27B, 27D, and 27F illustrate queries 2702, 2704, and 2706 for the electricity consumption tallies 1 to 3 which are associated with the “electricity meter 1” stream to “electricity meter 3” stream. Definitions of the queries are query definitions obtained by duplicating three copies of the electricity consumption tally query definition 302 of FIG. 3B in the stream and query duplicating module 2302, and giving each of the three copies a changed query name.

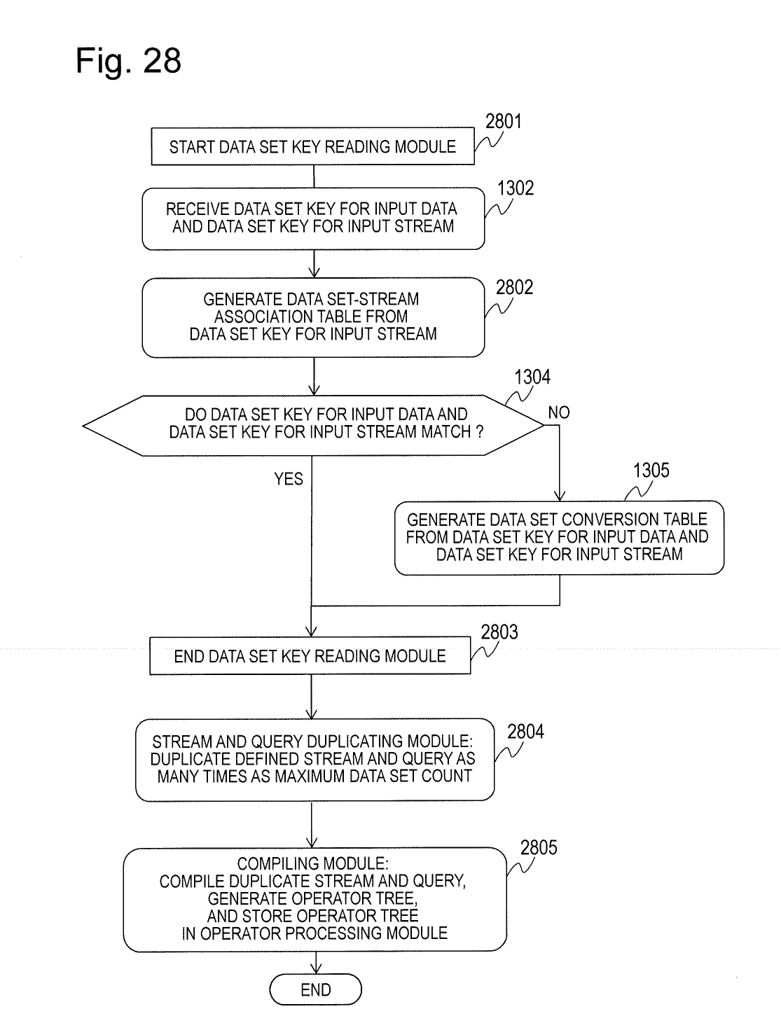

FIG. 28 is a flow chart illustrating an example of processing of the query registering module 111. The query registering module 111 uses the data set key reading module 211 to receive the data set key 205 from the registration server 105 (2801 and 1302). The query registering module 111 next generates, unlike in the first embodiment, the data set-stream association table 2305 from the data set key 304 for an input stream of the data set key 205 illustrated in FIG. 3C (2802). The generated data set-stream association table 2305 may contain data such as those of the entries 2503 to 2505 of FIG. 25, or may be an empty table devoid of data.

The query registering module 111 then generates the data set conversion table 210 in Steps 1304 and 1305 as in FIG. 13 of the first embodiment. After the processing of the data set key reading module 211 is finished (2803), the query registering module 111 uses the stream and query duplicating module 2302 to receive the stream and query definition 206 and the maximum data set count 2301 from the registration server 105, and to generate the duplicate stream and query definitions 2303 by duplicating a number of copies of the defined stream and query that is determined by the value of the maximum data set count 2301, and changing the names (2804).

The compiling module 212 of the query registering module 111 compiles the duplicate stream and query definitions 2303 generated by the duplication, to thereby generate a plurality of operator trees 228 (2805). The query registering module 111 stores the generated plurality of operator trees 228 in the operator processing modules 227 in different data executing modules #1 to #3. For example, in the case where the stream definition 301 and the query definition 302 are set as illustrated in FIGS. 3A and 3B of the first embodiment, and the maximum data set count 2301 is “3” as illustrated in FIG. 24, the query registering module 111 generates the duplicate streams (the “electricity meter 1” stream to “electricity meter 3” stream) 2701, 2703, and 2705 illustrated in FIGS. 27A, 27C, and 27E, and the query definitions (the “electricity consumption tally 1” query to “electricity consumption tally 3” query) 2702, 2704, and 2706 of FIGS. 27B, 27D, and 27F. From the duplicate stream and query definitions 2701 to 2706, the compiling module 212 generates three operator trees 228 (FIG. 6). The generated operator trees 228 are respectively output to the data executing modules #1 to #3 from the query registering module 111.

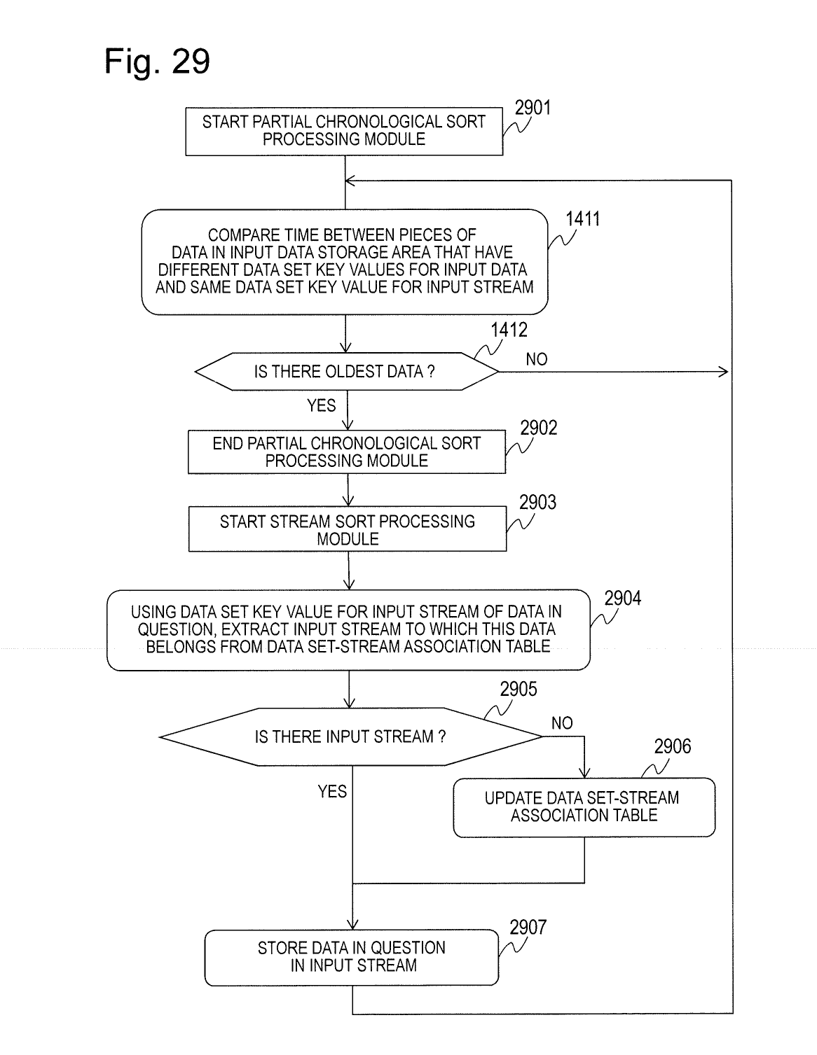

FIG. 29 is a flow chart illustrating an example of processing of the data inputting module 110. The data inputting module 110 uses the data set conversion table 210 to conduct input data receiving processing as in Steps 1402 to 1409 of FIG. 14 of the first embodiment, and sorts the input data in chronological order for each data set key value 402 for an input stream (FIG. 4) (1411). After the partial chronological partition processing module 209 of the data inputting module 110 finishes partial chronological partition processing (2902), processing of a stream partition processing module 2304 is started (2903).

The stream partition processing module 2304 uses the data set key value 2501 for an input stream of input data that has the earliest time to extract, from the data set-stream association table 2305, the input stream 2502 to which this data belongs (2905), and stores the data in the input stream 214 (2907). In the case where the input stream 2502 to which the data in question belongs is not extracted in Step S2905, the stream partition processing module 2304 adds to the data set-stream association table 2305 the data set key value 2501 for an input stream of this data and the name of the input stream 2502 that has not been allocated a data set (2906), and stores the data in the added input stream (2907). To store the data, the input stream 2502 provided for each data set key value 2501 for an input stream is processed by one of the plurality of data executing modules, #1 to #3, that is associated with the input stream 2502 as in conventional stream data processing systems, and the result of the processing is stored in the output stream 231.

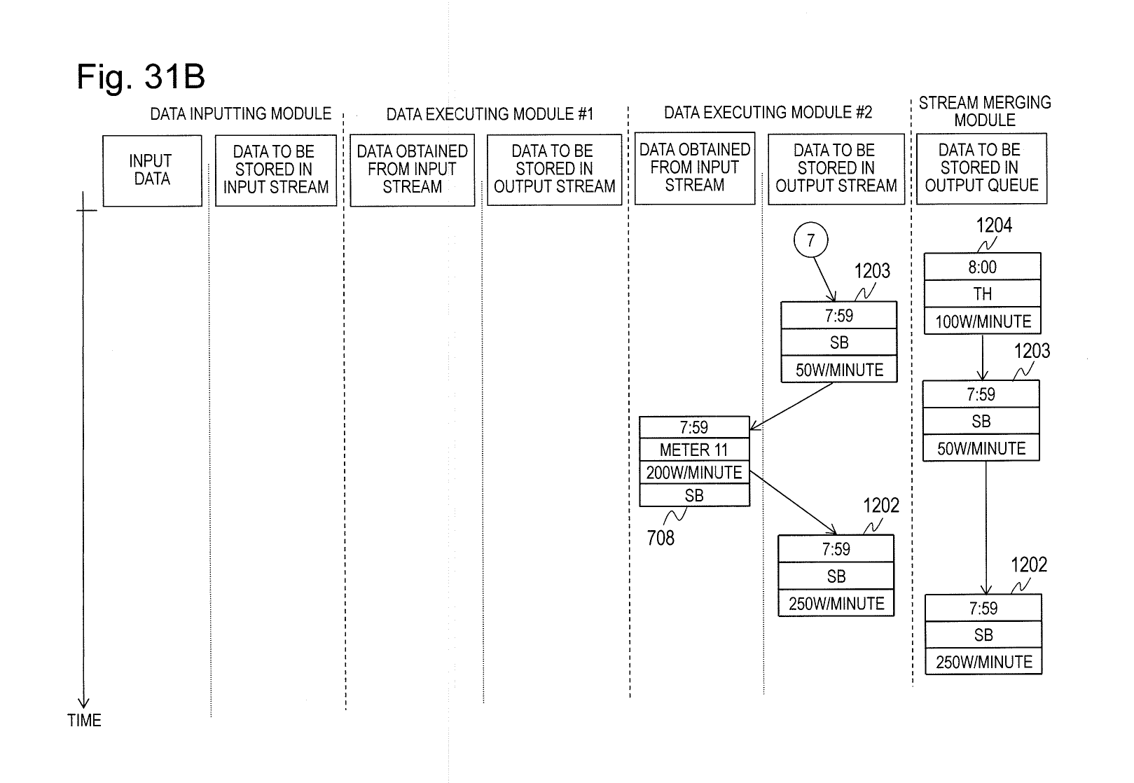

FIGS. 31A and 31B are time charts of the data inputting module 110, the data executing modules (#1 and #2) 112, and the stream merging module 2306. The data inputting module 110 receives the input data 706 to input data 708. The input data 707 of a data set “Tanaka residence” and the input data 706 and input data 708 of a data set “Sato Building” are each stored in one of the input streams 2502 (214) of the independent data executing modules #1 and #2 that is indicated by the data set-stream association table 2305 (FIG. 25). The data executing modules #1 and #2 store the output data 1204 and the output data 1203 plus the output data 1202, respectively, in the output streams 231.

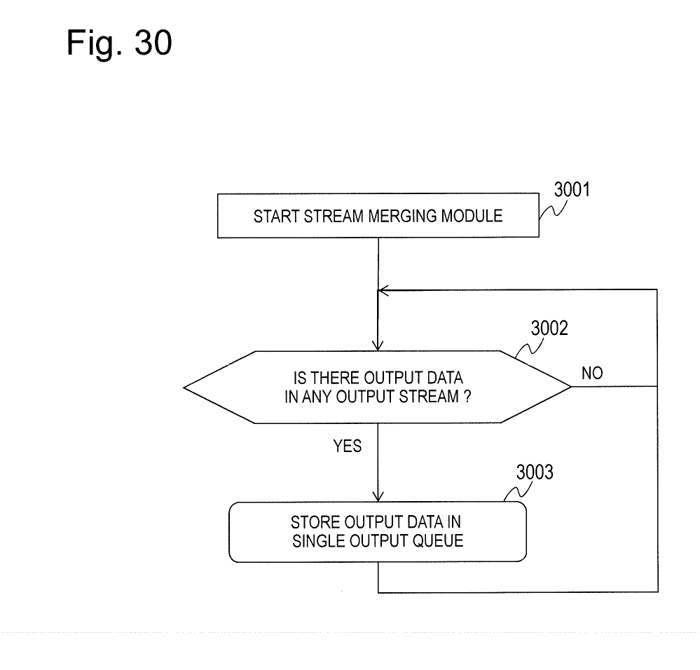

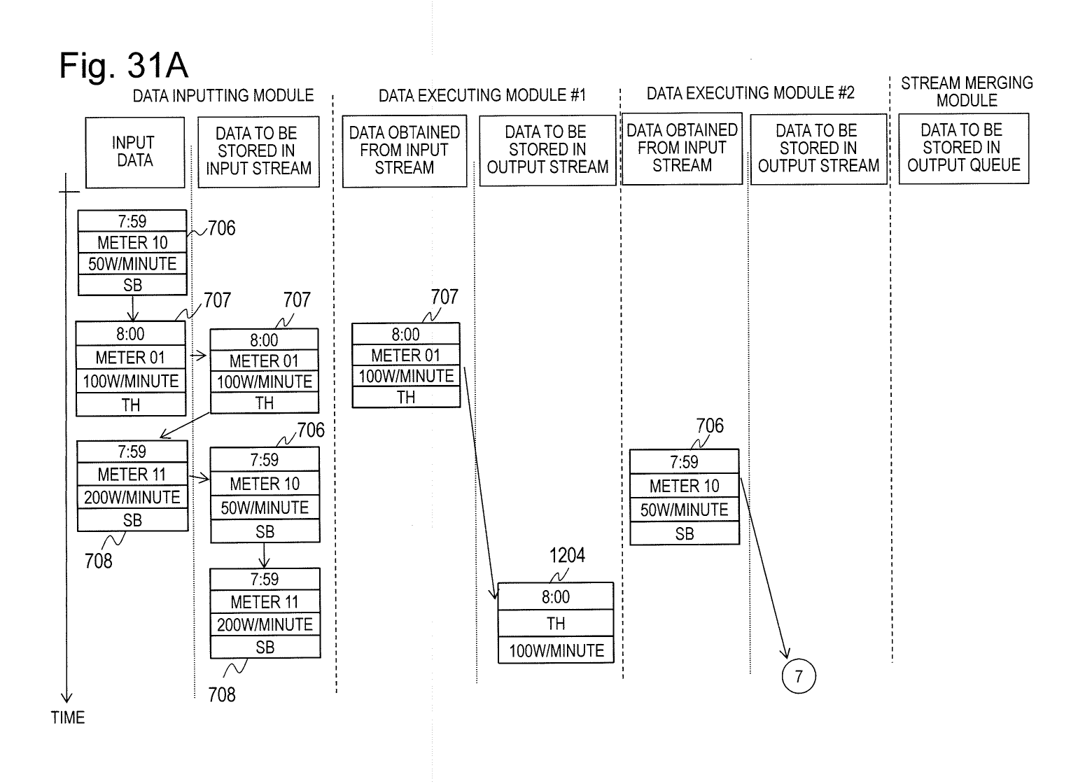

FIG. 30 is a flow chart illustrating an example of processing of the stream merging module 2306. As long as there is output data in one of the output streams 231 of the data executing modules #1 to #3 (3002), the stream merging module 2306 (3001) keeps storing the output data in the single output queue 2307 irrespective of which output stream has stored the output data (3003). For instance, the stream merging module 2306 stores the results of processing the input data 706 to input data 708 in the output queue 2307 as the output data 1202 to output data 1204 as illustrated in FIG. 26. The output data 1202 to output data 1204 stored in the output queue 2307 are transmitted to the receiving server 117 at given timing (e.g., in given cycles).

The third embodiment described above can attain the same effect as that of the first embodiment without changing the conventional stream data processing engine (the data executing modules #1 to #3). Alternatively, instead of specifying the maximum data set count 2301, a stream definition and a query definition may be duplicated dynamically to deal with an increase in the number of data set key values 2501 for an input stream when the data executing modules #1 to #3 execute processing. Streams and queries obtained by the duplication are compiled to be registered in the generated operator trees 228.

The first to third embodiments have discussed an example in which the data set key 205, the stream and query definition 206, and other types of settings information are received from the registration server 105. Alternatively, the stream data processing server 108 may be provided with an input device to receive the settings information from the input device.

A detailed description of this invention has now been given with reference to the accompanying drawings. However, this invention is not limited to the concrete configuration given above, and encompasses various modifications and equivalent configurations that fall within the scope of claims set forth below.

This invention is applicable to a computer system that performs stream data processing on input data containing time.

What is claimed is:

1. A stream data processing method for receiving stream data that is constituted of input data comprising time and executing processing of the stream data in accordance with a query registered in advance in a stream data processing device which comprises a processor and a memory,
the stream data processing device comprising:
a data inputting module which receives a plurality of pieces of input data constituting the stream data;
a query registering module which receives a first key, a definition of the stream data, and a definition of the query to generate operators for processing the plurality of pieces of input data, the first key specifying, as data sets, items of the plurality of pieces of input data that are used as units by which the plurality of pieces of input data are processed in chronological order; and
a data executing module which determines, for each of the data sets, which of the operators is to process the input data of the data set, and outputs a result of processing the input data of the data set with the operator,
the stream data processing method comprising:
a first step of receiving, by the query registering module, the first key, the definition of the query, and the definition of the stream data, and setting data sets to be processed in chronological order out of items comprised in the plurality of pieces of input data;
a second step of receiving, by the data inputting module, the plurality of pieces of input data to generate an input stream;
a third step of receiving, by the data executing module, the input stream and processing input data that is comprised in the input stream with the operators on a data set-by-data set basis; and
a fourth step of generating results of the processing of the operators as a single output stream.

2. The stream data processing method according to claim 1, wherein the third step comprises:
a fifth step of generating, by the data executing module, in the memory, execution areas for processing the plurality of pieces of input data on a data set-by-data set basis with use of items specified by the first key;
a sixth step of determining, by the data executing module, a data set to which input data that is comprised in the input stream belongs;
a seventh step of storing, by the data executing module, the input data that is comprised in the input stream in the execution area that is associated with the determined data set; and
an eighth step of processing, by the data executing module, the plurality of pieces of input data on an execution area-by-execution area basis with the operators.

3. The stream data processing method according to claim 2, wherein the fifth step comprises generating, by the data executing module, each of the execution areas in the memory when input data that is associated with the data set is received for the first time.

4. The stream data processing method according to claim 2, wherein the eighth step comprises storing, by the data executing module, in each of the execution area, one of the operators that processes the input data of the execution areas, stores a time at which the operator is to be executed as an ignition time, executing input data whose time matches the ignition time, and, as long as there is next input data which belongs to the same data set as the input data that has finished being processed and which is executable at the same time as the input data processed by the operator, processing the next input data with the operator.

5. The stream data processing method according to claim 2, wherein the eighth step comprises:
a ninth step of setting, by the data executing module, executable data information which stores, for each of the plurality of pieces of input data and for each of the operators, information indicating whether or not the input data is executable by the operator;
a tenth step of determining, by the data executing module, input data and an operator that are executable by referring to the executable data information; and
an eleventh step of updating, by the data executing module, the executable data information that is associated with the executed input data and operator.

6. The stream data processing method according to claim 1,
wherein the first step comprises receiving, by the query registering module, in addition to the first key which specifies items of the plurality of pieces of input data as the data sets, a second key which specifies items of the plurality of pieces of input data that are used as units by which the plurality of pieces of input data are sorted in chronological order, and
wherein the second step comprises, when generating an input stream by classifying the plurality of pieces of input data by the data sets with use of items that the first key specifies and sorting items of the plurality of pieces of input data that correspond to the second key in chronological order for each of the data sets, sorting, by the data inputting module, in chronological order, pieces of input data that have different values of the second key among pieces of input data that have the same value of the first key.

7. The stream data processing method according to claim 1,
wherein the first step comprises receiving, by the query registering module, the first key, the definition of the query, and the definition of the stream data, duplicating the definition of the stream data to define a plurality of input streams, and setting relations between the plurality of input streams and data sets to be processed in chronological order out of items comprised in the plurality of pieces of input data,
wherein the second step comprises receiving, by the data inputting module, the plurality of pieces of input data, classifying the plurality of pieces of input data by the data sets with use of items that the first key specifies, sorting the plurality of pieces of input data in chronological order for each of the data sets, and generating a plurality of input streams based on the relations between the data sets and the plurality of input streams,
wherein the third step comprises receiving, by the data executing module, the plurality of input streams separately, and processing input data that is comprised in the plurality of input streams on an input stream-by-input stream basis with the operators, and
wherein the fourth step comprises outputting each of results of processing the plurality of input streams with the operators to a single queue to generate output streams.

8. A stream data processing device for receiving stream data that is constituted of input data comprising time and executing processing of the stream data in accordance with a query registered in advance, the stream data processing device comprising:
a processor;
a memory;
a data inputting module which receives a plurality of pieces of input data constituting the stream data;
a query registering module which receives a first key, a definition of the stream data, and a definition of the query to generate operators for processing the plurality of pieces of input data, the first key specifying, as data sets, items of the plurality of pieces of input data that are used as units by which the plurality of pieces of input data are processed in chronological order; and
a data executing module which determines, for each of the data sets, which of the operators is to process the input data of the data set, and outputs a result of processing the input data of the data set with the operator,
the query registering module receiving the first key, the definition of the query, and the definition of the stream data, and setting data sets to be processed in chronological order out of items comprised in the plurality of pieces of input data,
the data inputting module receiving the plurality of pieces of input data to generate an input stream,
the data executing module receiving the input stream and processing input data that is comprised in the input stream with the operators on a data set-by-data set basis, and generating results of the processing of the operators as a single output stream.

9. The stream data processing device according to claim 8, wherein the data executing module generates, in the memory, execution areas for processing the plurality of pieces of input data on a data set-by-data set basis with use of items specified by the first key, determines a data set to which input data that is comprised in the input stream belongs, stores the input data that is comprised in the input stream in the execution area that is associated with the determined data set, and processes the plurality of pieces of input data on an execution area-by-execution area basis with the operators.

10. The stream data processing device according to claim 9, wherein the data executing module generates each of the execution areas in the memory when input data that is associated with the data set is received for the first time.

11. The stream data processing device according to claim 9, wherein the data executing module stores, in each of the execution area, one of the operators that processes the input data of the execution areas, stores a time at which the operator is to be executed as an ignition time, executes input data whose time matches the ignition time, and, as long as there is next input data which belongs to the same data set as the input data that has finished being processed and which is executable at the same time as the input data processed by the operator, processes the next input data with the operator.

12. The stream data processing device according to claim 9, wherein the data executing module sets, executable data information which stores, for each of the plurality of pieces of input data and for each of the operators, information indicating whether or not the input data is executable by the operator, determines input data and an operator that are executable by referring to the executable data information, and updates the executable data information that is associated with the executed input data and operator.

13. The stream data processing device according to claim 8,
wherein the query registering module receives, in addition to the first key which specifies items of the plurality of pieces of input data as the data sets, a second key which specifies items of the plurality of pieces of input data that are used as units by which the plurality of pieces of input data are sorted in chronological order, and
wherein when generating an input stream by classifying the plurality of pieces of input data by the data sets with use of items that the first key specifies and sorting items of the plurality of pieces of input data that correspond to the second key in chronological order for each of the data sets, the data inputting module sorts, in chronological order, pieces of input data that have different values of the second key among pieces of input data that have the same value of the first key.

14. The stream data processing device according to claim 8,
wherein the query registering module receives the first key, the definition of the query, and the definition of the stream data, duplicates the definition of the stream data to define a plurality of input streams, and sets relations between the plurality of input streams and data sets to be processed in chronological order out of items comprised in the plurality of pieces of input data,
wherein the data inputting module receives the plurality of pieces of input data, classifies the plurality of pieces of input data by the data sets with use of items that the first key specifies, sorts the plurality of pieces of input data in chronological order for each of the data sets, and generates a plurality of input streams based on the relations between the data sets and the plurality of input streams, and
wherein the data executing module receives the plurality of input streams separately, processes input data that is comprised in the plurality of input streams on an input stream-by-input stream basis with the operators, and outputs each of results of processing the plurality of input streams with the operators to a single queue to generate output streams.
